(19) United States
(12) Patent Application Publication
(10) Pub. No.: US 2015/0151995 A1
(43) Pub. Date: Jun. 4, 2015

(54) Water Treatment System and Method for Removal of Contaminants Using Biological Systems

(71) Applicant: FRONTIER WATER SYSTEMS, LLC, Salt Lake City, UT (US)

(72) Inventors: Timothy Michael Pickett, Salt Lake City, UT (US); James John Peterson, San Diego, CA (US)

(21) Appl. No.: 14/210,310

(22) Filed: Mar. 13, 2014

Related U.S. Application Data
(63) Continuation-in-part of application No. 13/803,904, filed on Mar. 14, 2013.
(60) Provisional application No. 61/842,381, filed on Jul. 3, 2013.
(60) Provisional application No. 61/842,382, filed on Jul. 3, 2013.

(51) Int. Cl. C02F 3/30; C02F 1/52; C02F 9/00

(52) U.S. Cl. CPC C02F 3/30; C02F 9/00; C02F 1/52

(57) ABSTRACT

A novel biologically active water treatment system for removing contaminant from industrial effluent and method thereof is provided. A novel upflow bioreactor system having an expanded bed configuration and method for creating an expanded bed for release of gas without release of substantial precipitate is also provided. A novel downflow bioreactor system having an automated degas and backwash system is also provided.

### PRIORITY

The present application is a continuation-in-part of U.S. patent application Ser. No. 13/803,904, filed on Mar. 14, 2013, and also claims the benefit of each of U.S. Provisional Patent Application Ser. No. 61/842,381, filed on Jul. 3, 2013, and U.S. Provisional Patent Application Ser. No. 61/842,382, filed on Jul. 3, 2013, each of which is incorporated herein by reference in its entirety.

### THE FIELD OF THE INVENTION

The present invention relates generally to water treatment systems and methods for removing dissolved contaminants from water using bioreactors. More specifically, the present invention relates to a multi-stage water treatment system and method for removing soluble metalloids, soluble metals, soluble metal complexes, perchlorate, mercury, arsenic, nitrates, and nitrites from water using multiple bioreactors and bacterial reduction to convert the contaminants to a form more easily removed from the water.

### BACKGROUND

Many industrial activities involve processes that produce an effluent containing contaminants, which at elevated levels are toxic or otherwise detrimental to human health, fish and wildlife. Some anthropogenic sources of contaminated effluent include mining, coal fired power plants, agricultural drainage, oil refining, and natural gas extraction. Effluent contaminants may include soluble metalloids, soluble metals, soluble metal complexes, perchlorate, methyl mercury, arsenic, nitrates, and nitrites.

For example, selenium is a naturally occurring metalloid, which can be released through anthropogenic activities such as mining and the combustion of coal. Dissolved forms of selenium, selenate and selenite, have been known to bio-accumulate in birds and fish, causing mutations and death. Selenium in small amounts is an essential nutrient for fish and other wildlife, but at high levels, may be toxic.

Excessive levels of nitrate in drinking water may have a negative impact on the health of human infants and animals. Nitrate poisoning may affect infants by reducing the oxygen-carrying capacity of the blood. The resulting oxygen starvation can be fatal. Once a water source is contaminated, the costs of protecting consumers from nitrate exposure can be significant.

Perchlorate, in large amounts, may interfere with iodine uptake into the thyroid gland. In adults, the thyroid gland helps regulate the metabolism by releasing hormones, while in children the thyroid helps in proper development.

Mercury may negatively affect the immune system, alter genetic and enzyme systems, damage the nervous system, and impair coordination and the senses of touch, taste, and sight. Indeed, fish consumption advisories for methylmercury now account for more than three-quarters of all fish consumption advisories in the United States.

Arsenic may also be toxic to animals, including humans, and is a known carcinogen associated with both skin and lung cancers. Contamination of potable water supplies with arsenic is of particular concern.

The United States Environmental Protection Agency (EPA) commonly regulates and provides guidelines regarding contaminant levels that may or may not be acceptable for discharging effluent and water for release into potable water supplies. Complying with EPA requirements and guidelines can be difficult and expensive. Moreover, in the future the EPA may tighten or increase regulations governing contaminants in water for discharge or release into potable water supplies.

In the past, various methods have been employed for removing certain contaminants from industrial effluent. Three conventional methods that have been used include iron co-precipitation, activated alumina treatment, and biological treatment. Biological treatment of industrial effluent has emerged as one of the more popular means of removing these contaminants.

Biological treatment of contaminated water is commonly conducted using a bioreactor system. Bioreactors used in industrial effluent treatment may include suspended growth bioreactors, fixed bed reactors, and fluidized bed reactors. A fixed bed reactor may also be referred to as a packed bed bioreactor. A fluidized bed reactor may also be referred to as an FBR.

A bioreactor may be used to reduce a soluble contaminant to an elemental precipitate or to a gas form that is more easily removed from the water. Reduction of soluble contaminants may be accomplished by bacterial reduction.

For example, bacteria colonies cultured in bioreactors may be used to convert contaminants such as nitrates into gas, which may be more easily removed from the system than the oxidized form. Heterotrophic bacteria may utilize the nitrate as an oxygen source under anoxic conditions to break down organic substances resulting in nitrogen gas as one of the end products. Perchlorate may also be converted to the chloride ion (Cl—) and arsenic converted to As(III) using bacterial reduction by way of a bioreactor.

Thus, bioreactors may provide an environment in which to grow and maintain bacterial cultures cultivated for reduction of a contaminant. The bioreactors may include an insoluble support or growth media to provide a surface area on which bacteria may colonize and form biofilm. The insoluble support or growth media may comprise granular activated carbon (GAC), sand, or similar insoluble media conducive to growth, development, and adherence of a bacteria colony and biofilm. Both fixed bed reactors and fluidized bed reactors may use granular activated carbon (GAC), sand, or similar insoluble media for maintenance of biofilms.

A biofilm (sometimes referred to as a bacteria biofilm or active biofilm) is a complex biological structure comprised of colonies of bacteria and other microorganisms, such as yeast and fungi. Water and other liquids passing through a bioreactor may be maintained in regular contact with the biofilm when the bacteria colony and biofilm are disposed on an insoluble support or growth media.

Thus, soluble contaminants may be precipitated or converted to a gas form using a bacterial reduction process by passing water through a bioreactor where contaminants in the water come into contact with a biofilm specifically cultivated for reduction of a contaminant. Conventional bioreactor systems have typically been configured to permit flow of contaminated water through the system so that contaminants come into contact with the biofilm.

For example, bioreactors for removing soluble selenium from effluent may comprise specially cultivated bacteria colonies disposed within GAC, sand, or a combination thereof, where the bacterial colonies form a biofilm. Bacteria are fed carbohydrate rich nutrients, which are directly supplied to the bioreactor to stimulate bacterial respiration and biofilm growth. Soluble selenium, typically an oxidized form of selenium such as SeO42-(selenate) and SeO32-(selenite) may be transformed to particulate elemental selenium using reduction by selenate or selenite bacterial respiration. Particulate elemental selenium may also be referred to as filterable selenium, colloidal selenium, fine elemental selenium particles, reduced elemental selenium particles, elemental selenium precipitate, or precipitate where the precipitate is a substance in solid form that separates from solution.

Reduction of selenate or selenite to elemental selenium particles occurs as water contaminated with selenate or selenite passes across the biofilm and the selenate or selenite is used in bacterial respiration. Selenate and selenite are very small particles typically less than 1 uM in size. When precipitated into elemental selenium particles, larger precipitated particles may be retained within the bioreactor while the water continues to pass through and out of the bioreactor system.

Similarly, bioreactors may be used to cultivate bacteria colonies disposed in GAC, sand, or some other insoluble growth media and convert contaminants, such as nitrates, to gas. As nitrate contaminated water passes through the bioreactor and comes into contact with the biofilm, the bacteria colony may use the nitrate as an oxygen source under anoxic conditions to break down organic substances and convert the nitrate into nitrogen gas in the process. Thus, nitrate may be converted to nitrogen gas by bacterial reduction. Perchlorate may also be converted to the chloride ion (Cl—) and arsenic converted to As(III) in a bioreactor using bacterial reduction.

However, there are some disadvantages to bioreactor systems currently available for remediating industrial effluent. For example, bioreactor systems are directly fed a carbohydrate nutrient to stimulate bacteria growth and respiration; and, the large amounts of carbohydrate nutrient may not be completely consumed. Unconsumed carbohydrate nutrient may reduce effluent quality. Consumption of carbohydrate nutrient may also result in increased carbonaceous (organic) compounds or particulate matter in the effluent, reducing water quality. The measurement of water quality based on carbonaceous compounds/organic matter in the water may be measured by determining the Chemical Oxygen Demand (COD) or the Biological Oxygen Demand (BOD). (BOD and COD are also sometimes used to refer to the carbonaceous compounds/organic matter in the water.)

Furthermore, conventional bioreactor systems do not effectively retain precipitates such as fine selenium particulates, thus reducing quality of effluent exiting the system.

Also, specific combinations of contaminants are of interest to certain industries. For example, recently proposed effluent guidelines for the steam electric power industry limit discharge of nitrate, selenium, mercury and arsenic. However, conventional bioreactors may not contemporaneously remove multiple species of contaminants effectively, particularly where bacterial reduction of different contaminant species may produce different end product forms (e.g., a precipitate versus a gas).

There are also other disadvantages to conventional bioreactor systems. Fixed bed reactors tend to be large in size due to low hydraulic loading requirements necessary for solids retention. Biological reactions within the bed produce gases such as nitrogen, carbon dioxide, and hydrogen sulfide through cellular respiration and fermentation reactions. Gas can build up in the bed, decreasing bed permeability and creating head-loss, impeding water flow through the bed.

Some fixed bed reactors currently being used in the industry attempt to address decreased bed permeability by increasing the liquid level above the bioreactor bed, thus increasing the driving hydraulic head needed to push liquid through the bioreactor bed. The driving hydraulic head (sometimes referred to as static head) may be increased by increasing the column of water above the bioreactor bed. The maximum amount of static head available may be limited by the tanks height and available freeboard above the bioreactor bed.

Freeboard is the extra space needed above the reactor bed to meet the hydraulic head requirement for effectively pushing water through the bed. The bioreactor tanks must be tall enough so the driving head is sufficient to overcome gas entrained in the bed, which may prohibit permeation. Freeboard may account for as much thirty percent (30%) or more of additional tank height above what is required for the bioreactor bed.

The increased height and large volume of fixed bed reactors generally makes them more expensive, harder to transport, and if housed in a building, may require more building height. Moreover, because of their large size, fixed bed reactors typically have to be constructed onsite, which increases construction costs.

Attempts have also been made to reduce problems associated with gas impediment using fluidized bed reactors. In a fluidized bed reactor, water is passed through a granular solid material at high enough velocities to suspend the granular material so it behaves as though it were a fluid. This process, known as fluidization, assists in the release of gas.

However, a fluidized bed has some disadvantages because of the fluidization and extreme agitation in the system. For example, a fluidized bed reactor does not effectively remove particulate matter such as colloidal selenium and mercury species. Moreover, there is a resulting increase in organic materials in the effluent. Consequently, fluidized bed reactors require recycling the effluent through the bioreactor using multiple passes in order to remove contaminant particulates.

Thus, it is desirable to have an improved biological system and method for the treatment of water that improves the quality of the effluent exiting the system, more effectively retains particulate elemental contaminants, improves permeability of a bioreactor bed and associated water flow, reduces problems associated with entrained gases, effectively reduces COD/BOD in the effluent, provides for concurrent removal of various contaminant species, reduces freeboard above a bioreactor bed, and allows for a smaller overall system footprint.

### SUMMARY OF THE INVENTION

It is an object of the present invention to provide an improved bioreactor water treatment system for removal of contaminants, such as soluble metalloids, soluble metals, soluble metal complexes, mercury, arsenic, perchlorate, nitrates, and nitrites, from water and method thereof.

In one embodiment of the present invention, a multi-stage water treatment system is provided for precipitating soluble selenium and removing the selenium precipitate from water. This multi-stage water treatment system may comprise an anaerobic (e.g., using anoxic respiration) fluidized bed reactor at a first stage, an aerator at a second stage, and one or more anaerobic or aerobic or partially aerobic bioreactors at a third stage. The anaerobic fluidized bed reactor may include a fluidized bed having a bacterial colony for reduction of soluble selenium. The one or more aerobic or partially aerobic bioreactors may comprise one or more fixed bed reactors or fluidized bed reactors, each having a bacteria colony associated with an insoluble growth media for reduction of soluble selenium.

The multi-stage water treatment system may include a filter at a fourth stage for removing residual selenium precipitate. In another aspect of the present invention, the multi-stage water treatment system may also include a second filter comprising a membrane filter for membrane concentration. The second filter may be comprised of an ultrafiltraion, microfiltration, reverse osmosis or nanofiltration system.

In another aspect of the present invention, water contaminated with soluble selenium may be fed into the multistage water treatment system into the anaerobic fluidized bed reactor at the first stage and then be recycled through the anaerobic fluidized bed reactor using multiple passes. Precipitated selenium and carbonaceous waste may be removed from the anaerobic fluidized bed reactor and transferred to a solids handling system.

Water treated by the anaerobic fluidized bed reactor or any other stage of the treatment systems may be transferred to an aerator at the second stage to introduce a desired level of dissolved oxygen into the water prior to transfer to an aerobic or partially aerobic bioreactor. Aeration may assist converting residual nutrient into biomass, which may be easier to filter from the water than the residual nutrient. Aerated water may then be transferred from the aerator to one or more aerobic or partially aerobic bioreactors for polishing at the third stage of the multi-stage water treatment system. Residual precipitate and biomass may be filtered through the one or more bioreactors at the third stage using a packed bed comprising an insoluble growth media suitable for cultivating a bacterial colony.

Precipitated selenium and carbonaceous waste may be removed from the one or more bioreactors and transferred to a solids handling system. Water treated by the one or more aerobic or partially aerobic bioreactors may be transferred to the filter at the fourth stage for further removal of residual selenium precipitate and carbonaceous material.

Filtered water may be discharged from the multi-stage biological water treatment system or further filtered through the membrane filter.

Filtered water may also be recycled through the aerator for further treatment in the one or more aerobic or partially aerobic bioreactors. Precipitated selenium and carbonaceous waste removed by filtration or membrane concentration may be transferred to a solids handling system.

The multi-stage water treatment system of the present invention provides improved removal of selenium precipitate and carbonaceous material before water exits system and permits filtering of water wherein membrane fouling is controlled or minimized.

Thus, in accordance with one or more aspects of the present invention, high-quality water may be produced having reduced BOD/COD and being suitable for direct discharge into live streams or into other wildlife habitats.

In another embodiment of the present invention, a multi-stage water treatment system is provided for removing contaminants such as soluble metalloids, soluble metals, soluble metal complexes, methyl mercury, perchlorate, arsenic, nitrates, and/or nitrites from water using bacterial reduction.

The multi-stage water treatment system may include an upflow bioreactor at a first stage and a downflow bioreactor at a second stage. The multi-stage water treatment system may also include a filtration system for removal of residual precipitate and carbonaceous material. The filtration system may be comprised of a membrane filtration or a media filtration system. The membrane filtration may include an ultrafiltration system, a microfiltration system, or a reverse osmosis filtration system. The multi-stage water treatment system for treating water in an upflow bioreactor system followed by treating water in a downflow bioreactor may allow substantial decoupling of a bioreduction stage of water treatment process from a filtration stage of water treatment process.

A chemical such as ferric chloride or an organosulfide may be introduced into the multi-stage water treatment system after one or more biological treatment stages to improve or increase reduction of soluble metals prior to filtration. Ferric chloride or an organosulfide may be injected into an effluent pathway between the upflow and downflow bioreactors. The ferric chloride or organosulfide may also be injected into an effluent pathway between the downflow bioreactor and a filtering system. Injection of ferric chloride or organosulfinde into the water treatment system may improve biological transformation and promote coagulation of biological material.

A solids handling system may also be provided for treating solids removed from a water treatment system at one or more stages of the water treatment system. The solids handling system may be comprised of a settling tank, a clarifier, or a settling pond.

In one or more aspects of the present invention, an upflow bioreactor may be provided having an expanded bed comprised of an insoluble growth media wherein a bacterial colony may be cultivated for reduction of effluent contaminants. The insoluble growth media of the expanded bed may be comprised of a biologically active GAC. Water may flow upwards through the upflow bioreactor bed at a rate sufficient to expand the bed without substantially fluidizing the bed, and wherein the upward flow of water assists removal of trapped gases from the expanded bed. The upflow bioreactor may provide for single pass treatment of contaminated water without the need to recycle effluent through the upflow bioreactor. The upflow bioreactor may also provide for concurrent reduction and removal of a plurality of contaminant species wherein end products of reduction of the various contaminants may have different forms or states of matter, such as solid and gas.

In one or more aspects of the present invention, a method is provided for producing an expanded bed suitable for use in an upflow bioreactor. An insoluble growth media, such as GAC, may be selected and disposed in a bioreactor housing. The insoluble growth media may be suitable for cultivating a bacteria colony for reduction of effluent contaminants. Water may be channeled into a lower region of a bioreactor housing near a lower region of the insoluble growth media, wherein the water may be pushed or pulled upward through the insoluble growth media towards a top end of the bioreactor housing at a rate sufficient to create a desired space between insoluble growth media granules without substantially fluidizing the bed. The expanded bed may be biologically active. The rate of water flow through the insoluble growth media may be sufficient to permit a biologically active bed to release gas, precipitate, and or carbonaceous matter resulting from biological activity. The expanded bed may be produced using a method comprising an upflow hydraulic loading rate of between about 2 and about 7 gpm/ft².

The expanded bed may also provide for concurrent reduction and removal of a plurality of contaminant species wherein end products of reduction of the various contaminants may have different forms or states of matter, such as solid and gas. In one or more aspects of the present invention, a method is provided for treating effluent contaminated with a plurality of contaminant species wherein the reduction end products of the various contaminants may have different resulting states of matter, such as gas and solid.

In one or more aspects of the present invention, a method is provided for managing growth of an expanded bed resulting from biological activity. The method for managing bed growth may comprise periodic air scouring to remove biomass from the insoluble growth media. Air scouring may include blowing air into the expanded bed through a diffuser to break up biomass accumulated on the insoluble growth media. A bypass valve may be provided in an effluent pathway at a downstream position from the upflow bioreactor for diverting biomass and carbonaceous matter to a waste or solids handling system during or shortly after air scouring.

In one or more aspects of the present invention, a downflow bioreactor may be provided having a packed bed comprised of an insoluble growth media wherein a bacterial colony may be cultivated for reduction of effluent contaminants. The insoluble growth media of the packed bed may be comprised of a biologically active GAC. The downflow bioreactor may be operated under a vacuum. Vacuum or negative pressure may be generated by an effluent pump pulling water out of the downflow bioreactor. The effluent pump may be associated with the downflow bioreactor for creating vacuum pressure within the bioreactor. Vacuum pressure generated within the downflow bioreactor may be used to decrease hydrostatic pressure needed to force water through the downflow bioreactor's bed, thus allowing the downflow bioreactor of the present invention to have a reduced hydraulic head and lower height compared to conventional gravity actuated bioreactors.

In one or more aspects of the present invention, a downflow bioreactor may include a mechanical apparatus for agitating the packed bed during a degas event to assist release of gas, precipitate, and or carbonaceous matter resulting from biological activity. The bed agitation device may comprise a drive shaft extending into the bioreactor bed, wherein the drive includes one or more substantially horizontal tines extending laterally through the bed that may be rotated at various depths. The bed agitation device may include a motor for actuating rotation of the drive shaft for agitating the bed during a degas event to assist with dislodging the entrained gas, precipitate, and or carbonaceous matter from the bioreactor bed.

A negative pressure gauge may also be associated with the downflow bioreactor at a downstream position for measuring pressure within the downflow bioreactor for measuring pressure within the bioreactor. Effluent pressure data may provide parameters for monitoring permeability of the downflow bioreactor bed. Effluent pressure data may also provide parameters for monitoring the rate of gas production for optimization of filtration. Effluent pressure data may also be used for monitoring solids retention in the downflow bioreactor bed.

In one or more aspects of the present invention, a system and method is provided for restoring the permeability of a packed bed in a downflow bioreactor. The method of restoring the permeability of a packed bed may include an automated backwash system for clearing entrained gas, biomass, or precipitates from the downflow bioreactor bed. Permeability of the bioreactor bed may be monitored using effluent pressure data associated with suction of effluent from a downflow bioreactor wherein suction pressure is directed through an effluent exit disposed in the downflow bioreactor below or adjacent to a bottom portion of the packed bed. Effluent pressure data may be obtained using an effluent pressure gauge connected to an effluent pathway at a position downstream from the packed bed.

As entrained gas and solids accumulate in the packed bed, a negative pressure change occurs associated with suction by the effluent pump because of reduced permeability of the packed bed. When suction pressure reaches a predetermined level or falls within a predetermined range, the effluent pressure gauge may signal a water pump motor to turn on to initiate pumping clean water from the filtration system into a backwash water conduit. The water pump may act as a backwash pump. In one or more aspects of the present invention, the effluent pressure gauge may signal the backwash pump to turn on when pressure associated with suction of effluent from the downflow bioreactor is between about 2 psi and about negative (−) 2 psi. Effluent pressure data may be communicated to a programmable logic controller which may be used for automating operations of the water treatment system. The programmable logic controller my turn on the backwash water pump in response to communications from the effluent pressure gauge.

The clean water from the filter system being pumped by the backwash pump may be directed by the backwash water conduit into the downflow bioreactor through a port in the bottom of the downflow bioreactor below or adjacent to a bottom portion of the packed bed. The upward force of the clean water being pumped into the bottom of the downflow bioreactor may help dislodge and blow out gas entrained in the packed bed. The dislodged gas may rise up through the water and be released from the downflow bioreactor through an exit port near a top area of the bioreactor. The backwash system may pump water into the bioreactor up through the packed bed for only a short duration to facilitate dislodging of gas without dislodging substantial amounts of solids or waste from the system.

After a backwash event to remove entrained gas from the packed bed, if effluent pressure data indicates that the packed bed has failed to recover permeability after gas flush, then failure to recover permeability may be caused by biomass, precipitate, or other solid waste accumulating in the packed bed. When effluent pressure data received shortly after gas flush indicates continued reduced permeability, the vacuum pressure control gauge may signal the backwash pump to initiate a biomass backwash event. The biomass backwash event, also known as a biomass flush, may continue until accumulated solids are transferred to a solids handling system. The biomass backwash event may continue for a substantially longer period of time than a gas backwash event. Parameters for triggering the solids backwash event and the duration of the backwash event may be preset in and operated by the programmable logic controller.

These and other novel aspects of the present invention are realized in a biological water treatment system and method for removing contaminants from water as shown and described in the following figures and related description. Additional novel features and advantages of the invention will be set forth in the detailed description which follows, taken in conjunction with the accompanying drawings, which together illustrate by way of example, the features of the invention.

### BRIEF DESCRIPTION OF THE DRAWINGS

Various embodiments of the present invention are shown and described in reference to the numbered drawings wherein:

FIG. 1 is a line diagram of a multi-stage water treatment system showing effluent pathways in accordance with one or more aspects of the present invention;

FIG. 2 shows a diagram of a fluidized bed bioreactor in accordance with one or more aspects of the present invention;

FIG. 3 is a flow chart of a method of treating contaminated water in accordance with one or more aspects of the present invention;

FIG. 4A shows a multi-stage water treatment system in accordance with one or more aspects of the present invention;

FIG. 4B shows a multi-stage water treatment system in accordance with one or more aspects of the present invention;

FIG. 4C is flow chart of a method of treating contaminated water in accordance with one or more aspects of the present invention;

FIG. 5A shows an upflow bioreactor having an expanded bed in accordance with one or more aspects of the present invention;

FIG. 5B shows an upflow bioreactor having an expanded bed in accordance with one or more aspects of the present invention;

FIG. 6 shows a multi-stage water treatment system in accordance with one or more aspects of the present invention;

FIG. 7 shows a multi-stage water treatment system in accordance with one or more aspects of the present invention;

FIG. 8 shows a downflow bioreactor having a packed bed in accordance with one or more aspects of the present invention;

FIG. 9 shows an automated degas and solids backwash system in accordance with one or more aspects of the present invention;

FIG. 10 is a data graph showing effluent pressure data associated with a degas event in accordance with one or more aspects of the present invention;

FIG. 11 is a flow chart of a method of removing gas from a bioreactor bed of a downflow bioreactor in accordance with one or more aspects of the present invention; and

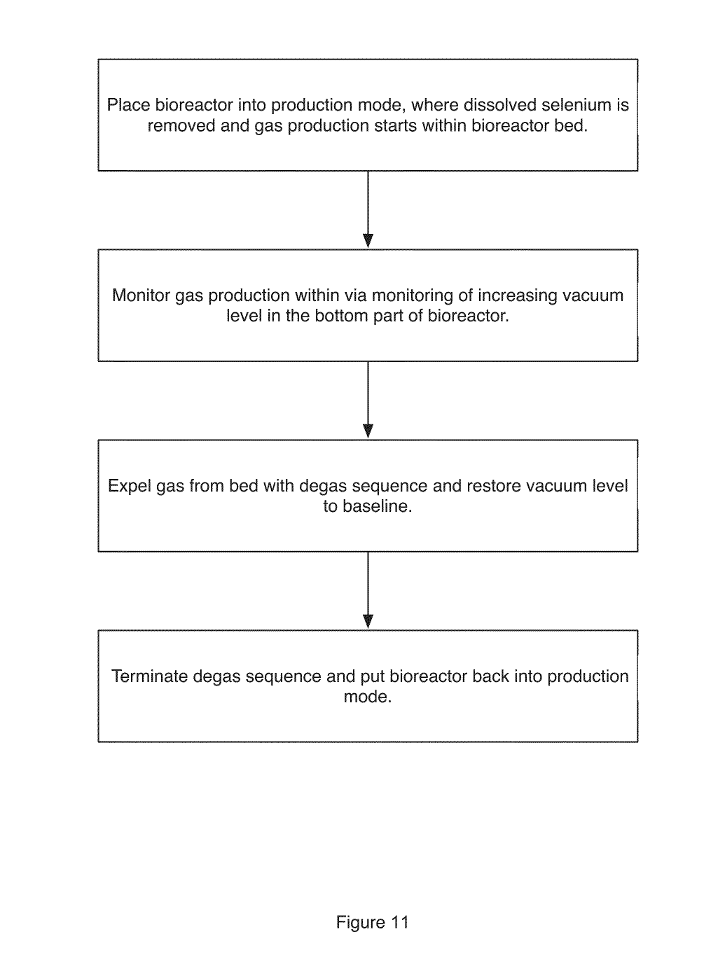

FIG. 12 shows a downflow bioreactor having a bed agitation device suitable for use during a degas event in accordance with one or more aspects of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed so as to enable one skilled in the art to practice the present invention. The drawings and descriptions are exemplary of various aspects of the invention and are not intended to narrow the scope of the appended claims. It should be understood that while some of the embodiments are shown operating in sequential steps or series, other embodiments operating multi-threaded processing, interrupt processing, and or multiple processors would also fall within the scope of the present invention.

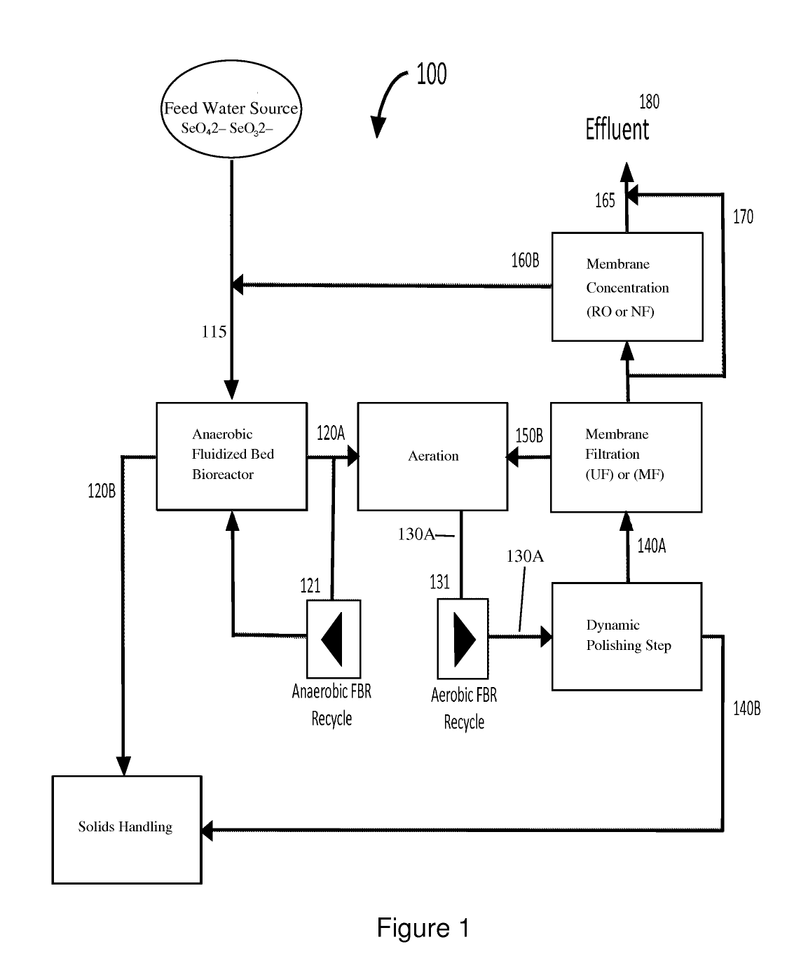

Turning now to FIG. 1, a biologically active multi-stage water treatment system 100 for removing soluble selenium from water is shown in accordance with one or more aspects of the present invention. The biologically active water treatment system 100 uses reduction occurring during anoxic bacterial respiration to reduce water contaminants from a soluble form to a precipitate form, which may be more easily removed from the water. A subsequent stage comprising passing contaminated water through a bioreactor operating under anaerobic, aerobic or partially aerobic bioreactor to remove residual nutrient allows for subsequent membrane filtration and membrane concentration stages without membrane fouling.

As shown in FIG. 1, the water treatment system 100 may be configured for receiving contaminated effluent or water from a contaminated effluent or water source 110. Contaminated effluent or water delivered into a water treatment system is sometimes referred to herein as feed water. The feed water may be contaminated with soluble (oxidized) forms of selenium such as selenate or selenite, which may be toxic to fish and other wildlife. The feed water source 110 may be a river, pond, lake, or other contaminated water source. The feed water source 110 may include a contaminated water output of an industrial plant or process. The feed water source may also be a conduit, a holding tank, or a reservoir receiving contaminated water from industrial processes, such as mine runoff, coal-fired power plant effluents, a groundwater seep, well, agricultural drainage or other anthropogenic sources.

The water treatment system 100 may comprise an anaerobic bioreactor 120 at a first stage, an aerator 130 at a second stage, and one or more aerobic bioreactors 140 at a third stage for polishing. Bioreactors 120, 140 may be configured to be biologically active. The anaerobic bioreactor 120 shown in FIG. 1 may be a fluidized bed reactor (“FBR”).

The multi-stage water treatment system 100 may also include a membrane filtration system 150 at a fourth stage for removal of residual precipitated selenium. The membrane filtration system 150 may remove, concentrate, and recover any remaining particulates that may be measured as Total Suspended Solids. The membrane filtration system 150 may comprise an ultrafiltration system or a microfiltration system.

The multi-stage water treatment system 100 may also include a membrane concentration system 160 at a fifth stage for removal of any residual dissolved selenium. The membrane concentration system may comprise a reverse-osmosis system or a nano-filtration system. Dissolved selenium removed by the membrane concentration system may be delivered to the feed water pathway between the feed water source 110 and the anaerobic FBR 120 for introduction back into the water treatment system 100 for further processing.

As shown in FIG. 1, a solids handling system 190 may also be provided for handling precipitate, biomass, and other solids removed during water treatment at each of the anaerobic FBR 120 stage and the dynamic polishing 140 stage. The solids handling system may be configured or suitable for separating solids from water. The solids handling system 190 may be comprised of a settling tank, a clarifier, or a settling pond. It is understood that other solids handling systems available to one skilled in the art may also be used.

As shown in FIG. 1, feed water may be introduced into the multi-stage water treatment system 100 from a feed water source 110 through a feed water pathway 115. The feed water pathway 115 may comprise a conduit made of PVC pipe or high-density polyethylene plastic (“HDPE”), or steel. It should be understood that feed water pathways used at various stages in any embodiments of the present invention may be made of any suitable material available to one skilled in the art, in addition to PVC, HDPE, and steel.

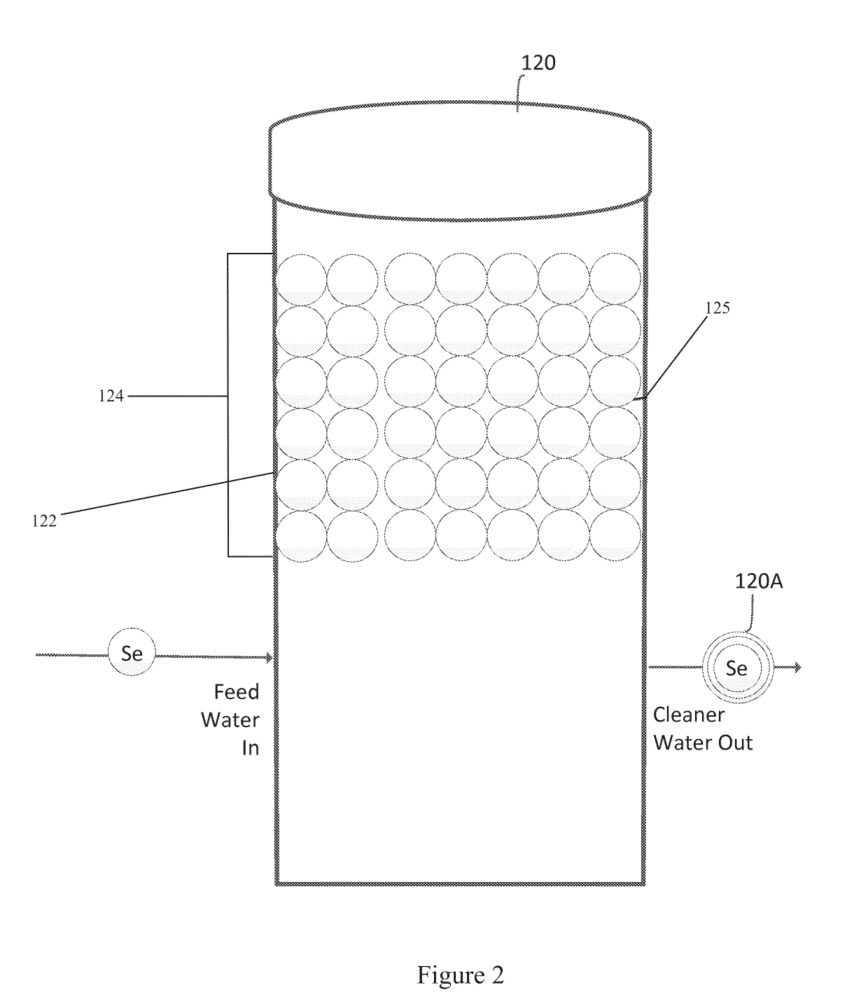

The feed water pathway may direct the contaminated water into an anaerobic FBR 120. As shown in FIG. 2, an FBR bioreactor may be comprised of a bioreactor housing 122 and bioreactor bed 124 disposed therein. The bioreactor housing 122 may be made of concrete, fiberglass, HDPE, or steel. It should be understood that bioreactor housings for bioreactors for various embodiments of the present invention may be made of any suitable material available to one skilled in the art, in addition to concrete, fiberglass, HDPE, or steel.

The bioreactor bed 124 may be comprised of an insoluble growth media 125 suitable for development of a bacteria colony thereon. Bacteria may colonize on the surface of the insoluble growth media 125. The use of selected insoluble growth media 125 in the anaerobic FBR 120 may provide high surface area for bacterial biofilm formation. The insoluble growth media 125 may include granular activated carbon (“GAC”), 30-90 mesh silica, sand, or a combination thereof. In a preferred embodiment the insoluble growth media 125 may be GAC. It will be appreciated that other insoluble growth media available to one skilled in the art may also be used. It is understood that the term insoluble growth media may include growth media that is substantially insoluble.

The bioreactor bed 124 in an FBR is fluidized by passing water through the granular insoluble growth media 125 at high enough velocities to suspend the granular material so it behaves as though it were a fluid. Fluidization of the bioreactor bed 124 may require recycling of effluent at a hydraulic loading rate of at least 10 gpm/ft² or greater.

The anaerobic FBR 120 may be operated under anaerobic conditions so that bacteria forming the biofilm may engage in anoxic or anaerobic respiration. The fluidized bed bioreactor may be fed a carbon based nutrient to stimulate bacterial growth and respiration. The carbon based nutrient may be comprised of acetate, glucose, molasses, methanol, or other carbon nutrient sources. It should be understood that other carbon based nutrients available to one skilled in the art may also be used.

Feed water entering the anaerobic FBR 120 passing through the fluidized bed may come into contact with the biofilm of the bacteria colony engaged in anaerobic respiration. Dissolved selenium, such as selenate or selenite, coming into contact with the biofilm may be transformed to a selenium precipitate through bacterial reduction. Selenium precipitate may be suitable for filtration.

The anaerobic FBR 120 biologically converts and removes contaminants from water by culturing a bacterial biofilm on an insoluble media support 125 that is fluidized by the up flow velocity of water. When water comes in contact with the biofilm, contaminants in the water may be reduced to a gaseous or solid form. The anaerobic FBR 140 may have a recycle system 121 to continually fluidize the FBR media at a desired flow rate. The recycle system 121 may allow for additional reduction of dissolved selenium and reduce the amount of dissolved selenium escaping to the next stage of the water treatment system. The anaerobic fluidized bed reactor 120 may include one FBR or two smaller FBRs to conserve height when freeboard is limited.

As active biology on the insoluble growth media precipitates dissolved selenium to particulate elemental selenium by biological reduction, filterable selenium waste produced in the anaerobic FBR 120 may integrate with biomass to yield a solid that may be transferred to a solids handling system 190. Bacteria growing in the FBR and reacting with dissolved selenium may produce a biomass component as the selenium is produced; resulting elemental selenium may integrate with the biomass during the biological reduction activity. Thus, filterable selenium may be incorporated into a sludge-like biomass material containing sludge which may be easier to separate from a water phase in the solids handling system 190.

The elemental selenium/biomass combination may be filtered, removed, and transferred through a waste stream 120B to the solids handling system 190 as a biomass waste product and later may be removed from the site for further processing or disposal.

After solids are removed from feed water treated in the anaerobic FBR 120, the treated water may be directed through a feed-water pathway 120A to an aerator 130 disposed between the aerobic FBR 120 and the one or more aerobic or partially aerobic bioreactors 140 at the dynamic polishing stage. The water treated in the anaerobic FBR 120 may contain residual selenium and organic compounds (measured as COD/BOD). Residual organic compounds may foul membrane modules making membrane filtration unfeasible. Dynamic polishing 140 may assist removal of residual COD/BOD to prevent or minimize membrane fouling. By managing dissolved oxygen levels in water prior to delivery of water to the one or more aerobic or partially aerobic bioreactors 140, the dynamic polishing stage 140 may be optimized to improve removal of carbonaceous matter while minimizing oxidizing and re-dissolving of residual selenium precipitate.

The aerator 130 may be a packed column, diffuse bubble aeration, or other aeration device. The aerator 130 may be used to introduce dissolved oxygen into the feed water stream from the upstream anaerobic FBR 120. The level of oxygen introduced to the stream can be varied from 0 to 14 mg/L to a desired set point. Dissolved oxygen levels may be optimized to balance a desired increase in consumption of residual carbon nutrient and increased production of biomass to be filtered at the dynamic polishing stage 140 with a desired low level of selenium precipitate oxidizing and re-dissolves into the water.

After aeration of treated water at the aeration stage 130, water may be directed through a feed water pathway 130A into one or more aerobic or partially aerobic bioreactors 140 for dynamic polishing to prepare the water for downstream membrane filtration. The dynamic polishing stage 140 may include a recycle system to fluidize the insoluble growth media 125 at a desired flow rate and or help control dissolved oxygen levels.

The one or more aerobic or partially aerobic bioreactors 140 comprising the dynamic polishing system may include one or more FBRs or one or more fixed bed bioreactors (also known as a packed bed bioreactor). The fixed bed bioreactor may be comprised of a bioreactor housing and a packed bed comprising an insoluble growth media 125 suitable for development of a bacteria colony thereon. Bacteria may colonize on the surface of the insoluble growth media 125, which may provide high surface area for bacterial biofilm formation. The insoluble growth media 125 may be granular activated carbon (“GAC”), 30-90 mesh silica, sand, or a combination thereof. In a preferred embodiment the insoluble growth media 125 may be GAC. It will be appreciated that other insoluble growth media available to one skilled in the art may also be used.

Unlike the fluidized bed of the FBR, the packed bed of a fixed bed bioreactor is not fluidized and may act as a media filter for removal of biomass and residual selenium precipitate.

The dynamic polishing system 140 may operate in complete anaerobic mode (no aeration), partial aerobic mode (partial aeration) or full aerobic mode (maximum aeration) depending on the level of dissolved oxygen introduced in the water at the upstream aeration system 130.

Aeration may be controlled by monitoring levels of dissolved oxygen using a dissolved oxygen sensor. Oxygen levels may be measured within the dynamic polishing system, e.g., within the one or more bioreactors 140 of the dynamic polishing system, or at the effluent stream 140A of the dynamic polishing system. Air flow may be adjusted upstream at the aeration stage 130. Air flow adjustment may be controlled by a programmable logic controller providing control signals to the aeration system in response to data received by the programmable logic controller from the dissolved oxygen sensor. The amount of dissolved oxygen in the dynamic polishing step can be adjusted in the range of 0 to 14 mg/L dissolved oxygen.

Biomass and precipitated selenium/biomass solids produced or retained in the dynamic polishing system 140 may be transferred to a solids handling system 190 through a waste stream channel 140B and later may be removed from the site for further processing or disposal.

After water has been treated by the dynamic polishing system 140, water may be directed to a membrane filtration system 150 for removal of residual selenium precipitate. The membrane filtration system may be a membrane bioreactor, a microfiltration filter, or an ultrafiltration filter. In a preferred embodiment, the membrane filter 150 may be an ultrafiltration membrane filter having a pore size of between about 0.1 to about 0.001 microns. In another preferred embodiment, the membrane filter 150 may be a microfiltration membrane filter having a pore size of between about 0.1 to about 3 microns. Water filtered by the membrane filtration system 150 may produce a clean permeate stream 150A and or a concentrate stream 150B. The clean permeate stream may be discharge from the water treatment system 100 as clean effluent 170.

The concentrate stream may be recycled to the aerator 130 or may be channeled to a membrane concentration system 160 for further filtering of water treated by the water treatment system. The membrane concentration system may comprise a reverse osmosis filter system or nanofiltration filter system.

Water filtered by the membrane concentration system 160 may also produce a clean permeate stream 165 and a concentrate stream 160B. The clean permeate may be discharged as clean effluent 180. The concentrate stream 160B containing residual dissolved selenium may be fed back to the feed water pathway 110 at the beginning of the water treatment system 100 for additional treatment.

The membrane concentration system 160 may include a bypass line 170, which allows for 0 to 100% of the flow from the downstream membrane filtration system 150 to be directed to the membrane concentration system 160. The fraction of water 150A from the membrane filtration step 150 that is not sent to the membrane concentration step 160 may be discharged as clean effluent 180 via the bypass line 170. Clean effluent discharged from the water treatment system after treatment of the feed water for selenium removal may be suitable for surface discharge, as opposed to human drinking water.

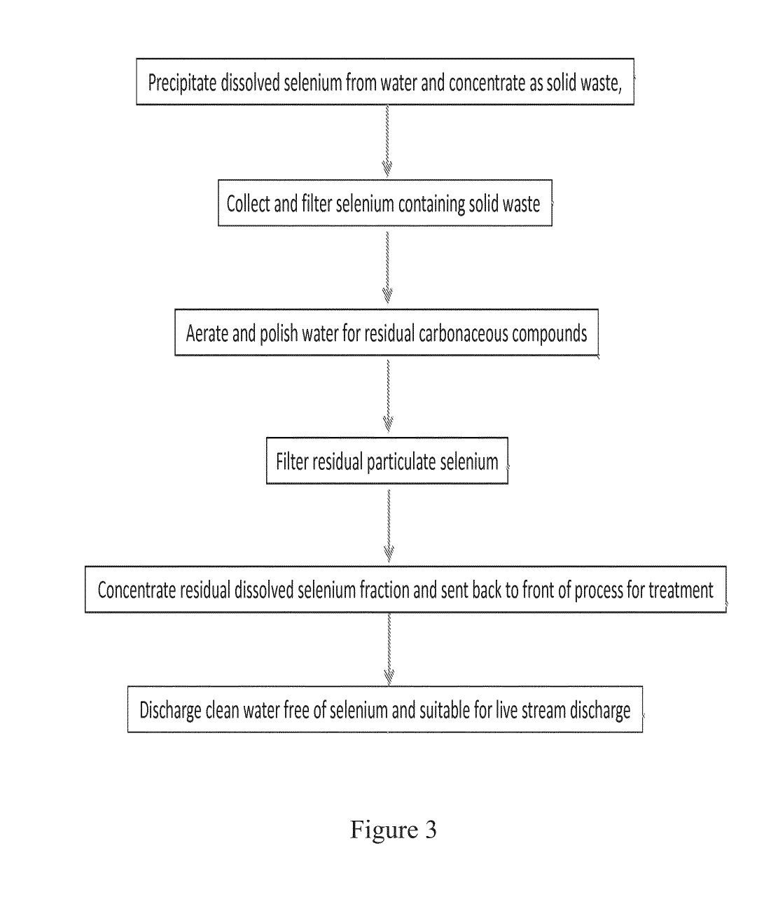

FIG. 3 illustrates steps of removing soluble selenium using a water treatment system 100 in accordance with one or more aspects of the present invention.

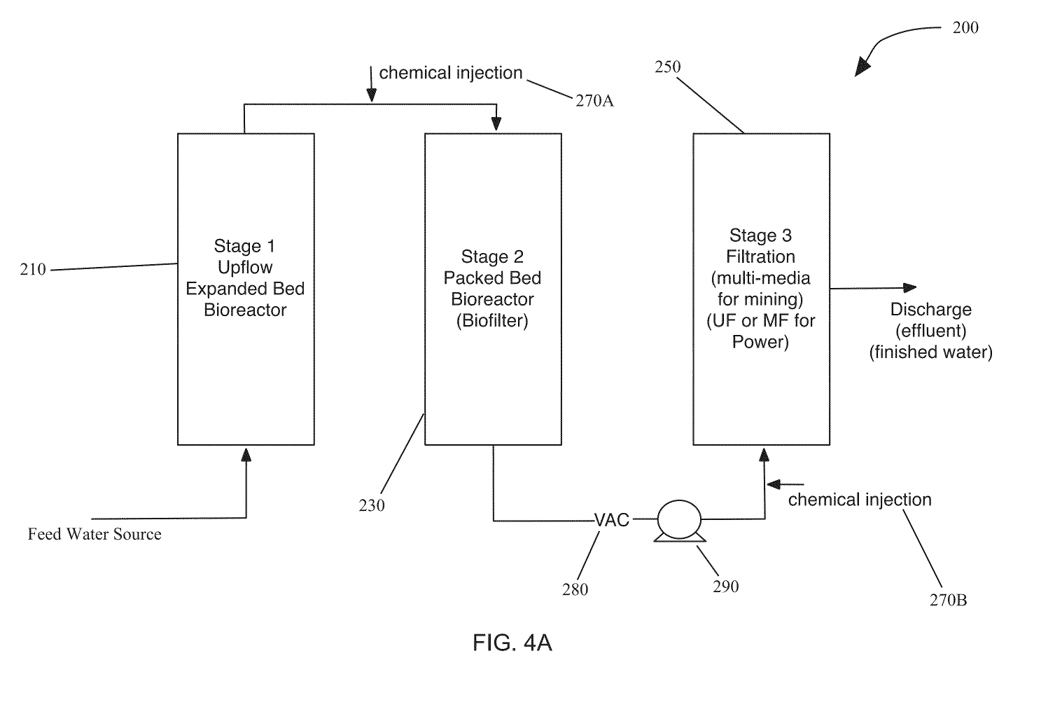

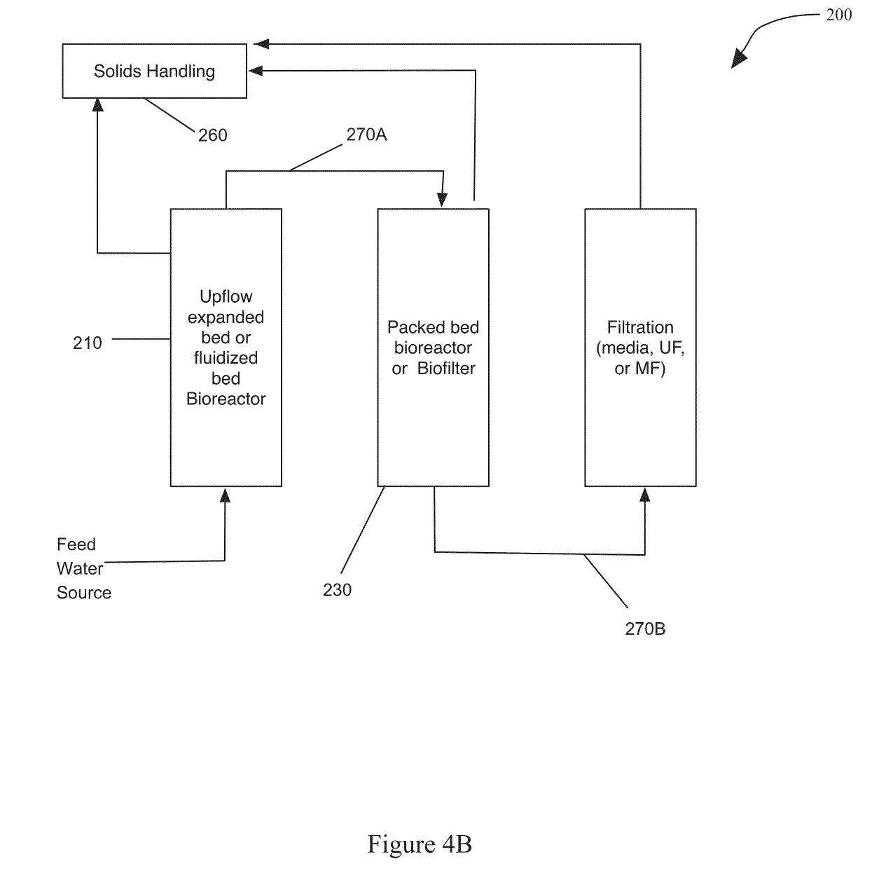

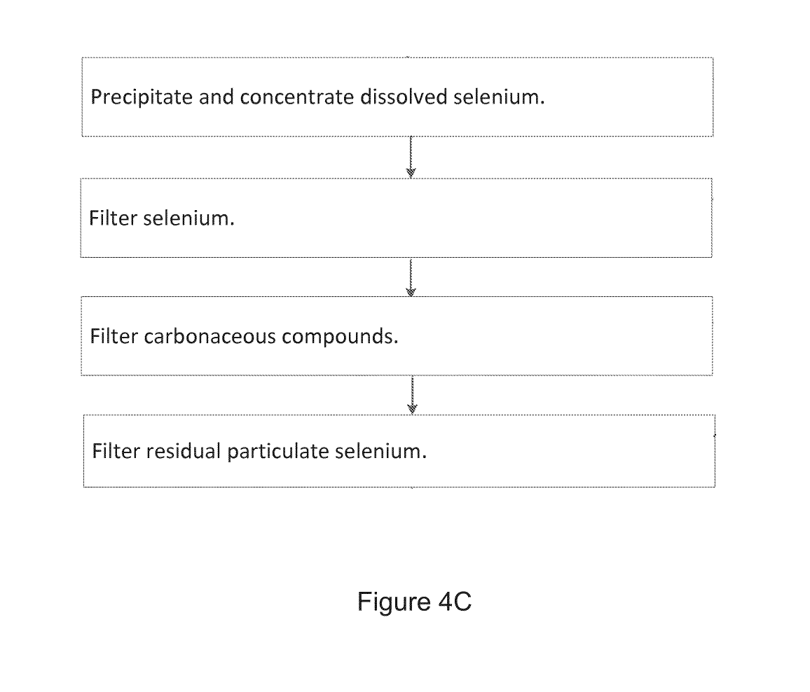

Turning now to FIG. 4A and FIG. 4B, another embodiment of a biologically active water treatment system in accordance with one or more aspects of the present invention is shown. As shown in FIG. 4, a multi-stage water treatment system 200 is provided comprising an upflow bioreactor 210 at a first stage, a downflow bioreactor 230 at a second stage, and a filtration system at a third stage. The upflow bioreactor 210 may include an expanded bed. The downflow bioreactor 230 may include a packed bed. The downflow bioreactor 230 having a packed bed may be referred to as a downflow biofilter.

As seen in FIG. 4B, the multi-stage water system 20 may include a solids handling system 260 for treating solids removed from water treatment system at one or more stages of the water treatment system 200. The solids handling system 260 may receive solid waste from the upflow bioreactor 210, from the downflow bioreactor 230, or from the filtration system 250. The solids handling system 260 may be comprised of a settling tank, a clarifier, or a settling pond. It is understood that any number of solids handling systems available to one skilled in the art may be used.

Various features and operations of the water treatment system may be controlled or managed by a programmable logic controller (sometimes referred to as a PLC). The programmable logic controller may interface with a touch screen computer having a graphical display showing water treatment system modes, parameters, and systems. The graphical interface may be associated with a Human Machine Interface (HMI).

The programmable logic controller may control or monitor a number of mechanical components of the water treatment system. For example, flow meters associated with water flow in water channels or conduits throughout the water system may send flow rate data to the PLC, including flow data associated with water flow at influent and effluent ports for each of the first and second stage bioreactors and for the filters and solids handling systems.

Automated valves may be provided which may be air actuated or electronically actuate may open and close to direct water for various modes of operation of the water treatment system, including service mode (e.g., treating the water), backwash mode, offline mode, startup, and taking bioreactor trains offline. Each operation may comprise a different valve configuration to direct water flow as needed for the mode operation. The PLC may send signal to open or close the automated valves and direct water flow for each mode of operation.

Flow control valves may be provided for adjusting water flow rate by partially opening or closing water channels, including for example influent and effluent ports. The flow control valves may open and close at variable parameters to meet a water flow set point. The flow control valves may open and close in response to communications received from the PLC. The PLC may control the opening and closing of the flow control valves in response to flow data received from flow meters. Thus the flow control valves may track to a set point.

Water pumps may also be provided, such as water pumps for driving feed water into the water treatment system, an effluent pump for pumping water out of a downflow bioreactor, and a backwash pump for pumping clean water back upward into a bottom of the downflow bioreactor and up through the packed bed for dislodging gas or for backwashing solids. The pumps may be fixed speed pumps with only on/off modes or may be variable frequency drive (VFD) pumps that operate at variable speeds between 0% and 100% to meet a water flow set point as measured by a downstream flow meter. The water pumps may be operated or controlled by the PLC in response to communications or data received from various sensors, such flow meters and pressure gauges.

Pressure gauges may also be provided for measuring pressure and sending pressure data to the PLC. Pressure gauges, such as an effluent pressure gauge, may be disposed downstream of bioreactors to measure effluent pressure to track gas formation as a measurement of biological activity rate in a bioreactor bed. Effluent pressure may also be used to measure bed permeability.

The water treatment system may also include other instruments for measuring turbidity, pH, and oxidations reduction potential such as turbidity meters, probes that measure scattered light, electrode probes for measuring pH and oxidation reduction potential. Bed level may be measured using a sonar or ultrasonic sludge blanket detector and or using turbidity. Turbidity data may also be used to measure filtration efficiency. Data from these instruments may be communicated to the PLC which may monitor or adjust water treatment system modes or operations in response to the data received.

A chemical metering pump may also be provided for injecting chemicals into channels where desired. The rate of chemical injection by the chemical metering pump may be regulated by the PLC in response to date received by the PLC from sensors such as flow meters.

Thus, many of the water treatment operations may be automated or controlled using a PLC. It should be understood that the PLC and other referenced valves, pumps, motors, gauges and other measuring devices may be used as desired in other embodiments of the present invention as well.

Industrial effluent containing soluble selenium or other contaminants may be fed into the water treatment system 200 from a feed water source and directed into the biologically active upflow bioreactor 210 for single pass treatment of the feed water. A carbon based nutrient may be introduced into the feed water before it is fed into the upflow bioreactor 210 to stimulate bacterial growth and respiration as it comes into contact with the biological colony growing on the upflow bioreactor bed 214. The feed water may mixed with a biological growth substrate, including macro nutrients such as carbon, nitrogen, and phosphorous and micro nutrients such as molybdenum, cobalt, zinc, and nickel which may be fed through the bottom of the reactor It should be understood that other micro nutrients available to one skilled in the art may also be used.

The environment in the upflow bioreactor may be maintained in a substantially anaerobic condition to foster bacterial reduction. In an aspect of a preferred embodiment, the water treatment system 200 may be configured for about 80% reduction of soluble contaminants at the upflow bioreactor 210 stage. The expanded bed of the upflow bioreactor 210 may allow for concomitant release of gas and retention of particulate selenium.

After single pass treatment of feed water in the upflow bioreactor 210, the effluent may be directed through a water conduit to the downflow bioreactor for further treatment. A chemical injection system 270A may be associated with the feed water pathway between the upflow bioreactor 210 and the downflow bioreactor 230. A chemical such as ferric chloride or an organosulfide may be introduced into effluent from the upflow bioreactor 210 to improve or increase reduction of soluble metals prior to biofiltration. Injection of ferric chloride or organosulfide into effluent from the upflow bioreactor 210 may promote coagulation of biological material in the downflow bioreactor 230. The rate of chemical injection may be regulated by communications to the chemical injection system from the programmable logic controller. The rate of chemical injection may be regulated in response to data received by the programmable logic controller from sensors such as flow sensors.

The downflow bioreactor 230 may include a biologically active packed bed for further reduction of any residual dissolved selenium or other reducible contaminants and may act as a biofilter for media filtering of any particulate selenium or other contaminant precipitate remaining in effluent from the upflow bioreactor 210. The downflow bioreactor 230 may also consume residual nutrient that may carry over from the upflow bioreactor 210 and convert it into biomass.

In an aspect of a preferred embodiment, no or little additional nutrient is introduced into effluent after leaving the upflow bioreactor 210 so that carbon consumption in the downflow bioreactor 230 may be substantially complete. In another aspect of a preferred embodiment, the water treatment system 200 may be configured for about 20% reduction of soluble contaminants at the downflow bioreactor 230 stage. An advantage of using a downflow bioreactor 230 to direct water “down” through a packed bed is improved retention of solids.

The multi-stage water treatment system's 200 novel configuration of a preliminary upflow bioreactor 210 stage followed by a secondary downflow bioreactor 230 stage for biofiltration provides for a high quality water stream suitable for discharge or release into the environment. The multi-stage water treatment system 200 may produce a high quality effluent by decoupling the selenium reduction and solids removal, while polishing the water for residual COD/BOD removal.

Also, using an upflow bioreactor 210 with an expanded bed followed by a downflow bioreactor 230 having a packed bed allows for a smaller overall system footprint. The removal of gas by the upflow bioreactor 210 while retaining selenium or other contaminant precipitate allows for improved permeability of the downflow bioreactor 230 packed bed and thus reduces the hydraulic head needed to push water through the packed bed. Thus, the downflow bioreactor 230 at the second stage may be smaller compared to conventional fixed bed bioreactors which require a deep bed and long contact time to achieve both selenium precipitation and solids retention.

As seen in FIG. 4A, the downflow bioreactor 230 may also be associated with a downstream effluent pump 290 to pull water from the downflow bioreactor 230 down through the packed bed. Vacuum assisted transfer of water through the packed bed further reduces the hydraulic head need for pushing water through the packed bed, thus further allowing for a small downflow bioreactor 230 footprint and for an overall smaller water treatment system 200 footprint.

Another advantage to using an upflow bioreactor 210 with an expanded bed followed by a downflow bioreactor 230 having a packed bed is that it may provide for reduced COD/BOD in the effluent. The reduced COD/BOD allows for subsequent membrane filtration without substantial membrane fouling. The effluent water may also be suitable for direct discharge into live streams and into fish and other wildlife habitats.

As seen in FIG. 4A and FIG. 4B, effluent from the downflow bioreactor 230 may be directed through an effluent conduit to a filtration system 250 for further polishing of the effluent. The filtration system may be a media, multimedia, or membrane filtration system. In one or more aspects of a preferred embodiment for the treatment of mining effluent, the filtrations system 250 may be a multi-media filtration system. In one or more aspects of a preferred embodiment for the treatment of power plant effluent, the filtration system may be an ultrafiltration system or a microfiltration system. The ultrafiltration membrane filter may have a pore size of between about 0.1 to about 0.001 microns. The microfiltration membrane filter may have a pore size of between about 0.1 to about 3 microns.

Removal of contaminants such as dissolved selenium may be improved at the filtration stage by use of a chemical injection system 270 associated with the feed water pathway between the downflow bioreactor 230 and the filtration sytem 250. A chemical such as ferric chloride or an organosulfide may be introduced into effluent from the downflow bioreactor 230 for increased reduction of soluble metals prior to filtration. The rate of chemical injection may be regulated by communications to the chemical injection system from the programmable logic controller. The rate of chemical injection may be regulated in response to data received by the programmable logic controller from sensors such as flow sensors.

Thus, another advantage of the present invention includes removal of ultra-low levels of selenium precipitate (<5 ug/L total selenium) by membrane filtration of fine particulate selenium. In conventional selenium treatment bioreactors, the particulate selenium can escape the bed and contribute to selenium in the effluent. The reduction of effluent COD/BOD to facilitate membrane filtration without membrane fouling allows removal of escaped selenium precipitate from the effluent. The membrane filtration system may remove, concentrate, and recover any remaining particulates that may be measured as Total Suspended Solids.

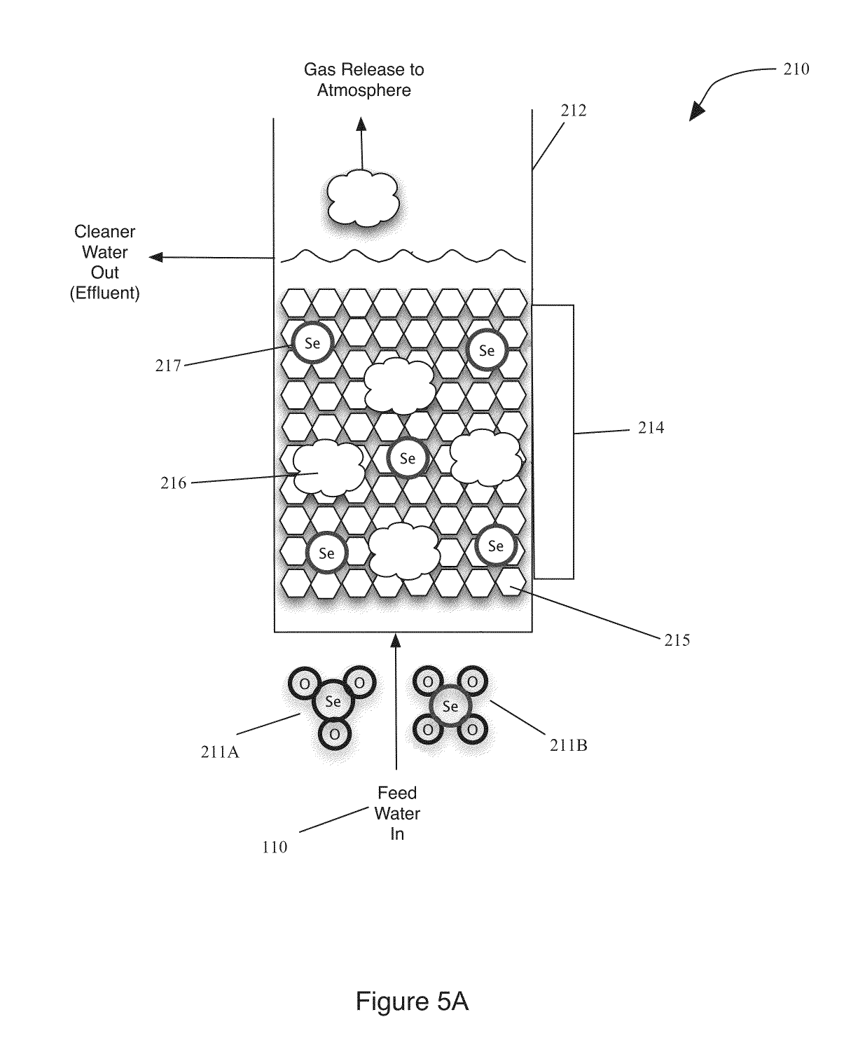

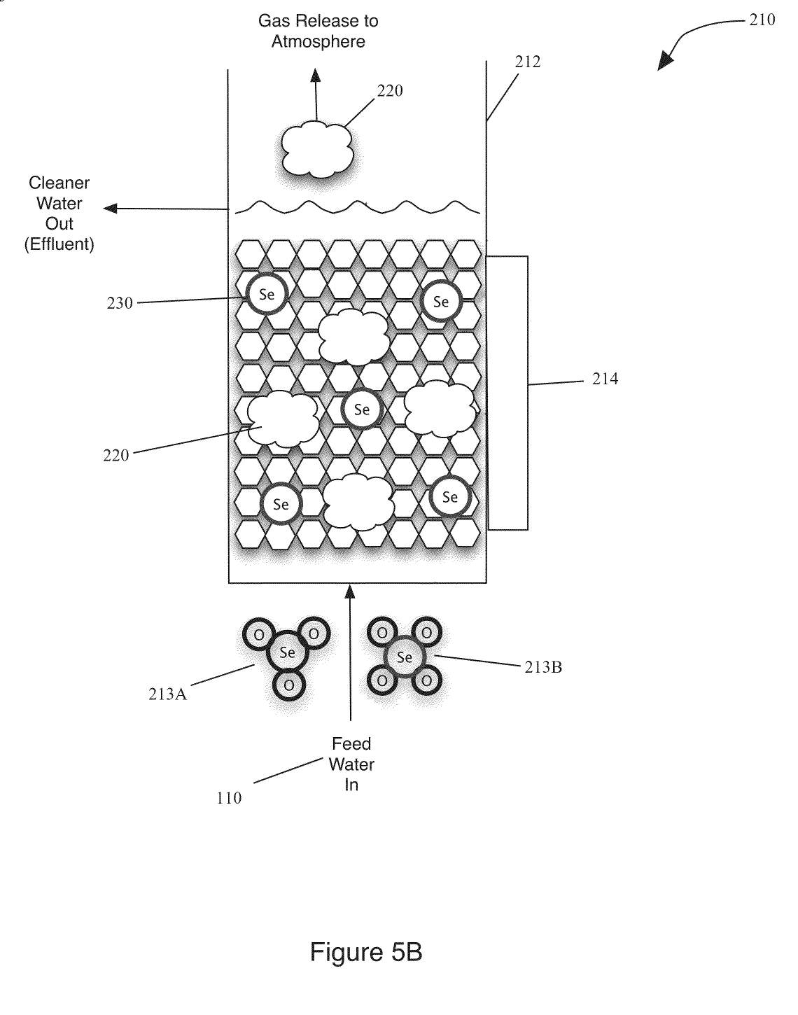

A number of unique advantages are also provided by the novel configuration of the upflow bioreactor 210. As shown in FIGS. 5A and 5B, the upflow bioreactor 210 may comprise a bioreactor housing 212 having a bioreactor bed 214 disposed therein. The bioreactor bed 214 may be configurable in an expanded bed formation. The bioreactor housing 212 may be made of carbon steel, coated carbon steel, stainless steel, fiberglass, or plastic. It should be understood that the bioreactor housings of the present invention may be made of any suitable material available to one skilled in the art, in addition to carbon steel, coated carbon steel, stainless steel, fiberglass, or plastic. The bioreactor housing may be made using molding, machine casting, or any other method available to one skilled in the art, which may depend on the material used to make the bioreactor housing.

The upflow bioreactor 210 may be configured for receiving feed water from a lower region of the bioreactor bed 210 so that water may flow substantially upward through the bed 214 of the upflow bioreactor 210. The bioreactor bed 214 may be an expanded bed comprised of an insoluble growth media 215 suitable for development of a bacteria colony thereon. Bacteria may colonize on the surface of the insoluble growth media 215. The use of selected insoluble growth media 215 in the biologically active bioreactor may provide high surface area for bacterial biofilm formation. The insoluble growth media 215 may include granular activated carbon (“GAC”), 30-90 mesh silica, sand, or a combination thereof. In a preferred embodiment the insoluble growth media 125 may be GAC. It will be appreciated that other insoluble growth media available to one skilled in the art may also be used.

The expanded bed 214 of the upflow bioreactor 210 may be formed by channeling feed water through the bottom of the upflow bioreactor 210 so that water is pushed or pulled evenly up through the insoluble growth media 215. The water may be evenly dispersed up through the bioreactor bed 214 using a water distribution system. In a preferred embodiment, the bioreactor bed 214 may be extended by pushing or pulling water up through the bioreactor bed 214 at a flow ranging from between about 2 to about 7 gallons per minute per square foot (gpm/ft²) tank area, or an upflow velocity of 25 to 60 feet per hour (ft/hr).

Operating with an upflow hydraulic loading rate of between about 2 and about 7 gpm/ft² allows for gas resulting from biological activity to escape past the insoluble growth media 215 with the momentum of the water without disrupting the bed in a manner that may release substantial amounts of reduced selenium precipitate. The empty bed contact time (EBCT) of the upflow bioreactor 210 may vary from 5 minutes to 40 minutes depending on feed water temperature and the level of contaminant removal needed.

Bed expansion ranges between about 10% and about 40% of a static level and may be completed using a single pass flow with no recycle of the effluent to the upflow bioreactor 210 feed. Bed expansion may be measured using impedance spectroscopy or turbidity to evaluate the height of the bed. Impedance spectroscopy or turbidity may also be used to evaluate growth of the bed 214 from biofilm growth and incomplete expulsion of gas. When the expanded bed reaches a specified height, impedance spectroscopy or turbidity sensors may trigger either a mechanical backwashing event that is used to remove a portion of the biofilm or a short pulse to release any entrained gas.

Use of an upflow bioreactor 210 having an expanded bed 214 allows for concomitant release of gas and retention of precipitate. Furthermore, use of an upflow bioreactor 210 having an expanded bed 214 may allow improved reduction of contaminants while reducing EBCT and overall pre-discharge water treatment time without recycling effluent at the primary bioreactor.

Hydraulic loading rates greater or lower than the preferred range may not concomitantly accomplish of the benefits allowed by an expanded bed 210 configuration. Water flowing up through the bottom of a bioreactor bed at hydraulic loading rates equivalent to greater than 10 gpm/ft2 may fluidize the insoluble growth media 215 which allows for release of precipitated selenium from the bioreactor bed 214. A fluidized bed may require recycling the treated water to obtain optimal water treatment.

Alternatively, water flowing up through the bottom of a bioreactor bed at hydraulic loading rate velocities of less than 2 gpm/ft2 results in a packed or fixed bed which tends to retain gas resulting from biological activity. A biologically active packed bed tends to lose permeability over time because of entrained gas.

In one or more aspects of the present invention, the influent water feed rate is controlled to a low enough level to optimize the benefits of plug flow, eliminating the recycle and concentration of waste products from the effluent of the upflow bioreactor 210, reducing impact energy between the particles, allowing for greater biomass retention, and allowing more effective removal of biomass/reduction precipitate matter from water before delivering effluent to subsequent stages of the water treatment system 200. The feed rate may be maintained at a high enough rate sufficient to expand the bed and allow release of gas 216 during treatment, which is not possible using the low non-fluidizing upflow velocities previously used in the industry. The gas 216 generated within the bed due to microbial respiration and fermentation may be released from the expanded bed 214 and carried to the top of the bed 214 and expelled to the atmosphere.

Over time, the expanded bed 214 level may increase because of bed growth caused by biology growth on the insoluble growth media 215. Growth of the bioreactor bed 214 may extend upward and begin to decrease the efficiency of the bioreactor 210 or interfere with effluent flow.

In one or more aspects of the present invention, a method is provided for automatically managing growth of an expanded bed resulting from biological activity. The method for managing bed growth may comprise periodic air scouring to remove biomass from the insoluble growth media. Air scouring may include blowing air into the expanded bed through a diffuser to break up biomass accumulated on the insoluble growth media. A bypass valve may be provided in an effluent pathway at a downstream position from the upflow bioreactor for diverting biomass and carbonaceous matter to a waste or solids handling system during or shortly after air scouring.

The expanded bed 214 level may be measured by measuring turbidity using turbidity meter or probes that measure scattered light. The bed level of the expanded bed 214 may also be measured using a sonar or ultrasonic sludge blanket detector and or using turbidity. The programmable logic controller may control an air scour system and may turn the air scour system on or off in response to data received from turbidity sensors or from a sonar or ultrasonic sludge blanket detector. The air scour system may be disposed adjacent to the bioreactor bed and configured so that air may be flown into the insoluble growth media to remove accumulated biological matter or growth.

Thus, a significant advantage of configuring the bioreactor 210 with an expanded bed 214 is the ability to optimize hydraulic loading for retention of reduction precipitate and solids and the concomitant removal of gas from the bed. For example, the biological reduction of oxyanions such as selenate and selenite will produce nanoparticles. These submicron particles can more easily be retained within the bed by controlling the water flow rate to avoid bed fluidization while still operating the upflow bioreactor 210 just above the minimum upflow velocity required for expulsion of gas.

Another advantage to the upflow bioreactor 210 being configured with an expanded bed in accordance with the present invention is the ability to concurrently reduce multiple contaminant species from which reduction produces end products having different states of matter. For example, reduction of selenate and selenite results in a selenium precipitate (e.g., a solid); reduction of nitrate and nitrite results in nitrogen (e.g., a gas); and the reduction of perchlorate results in a soluble chloride ion. The use of an upflow bioreactor 210 configured with an expanded bed 214 may allow for the concurrent treatment of these and other contaminant species. The ability of the expanded bed 214 configuration of the upflow bioreactor's 210 to concurrently reduce various contaminant species having different end product forms may be facilitated by its ability to concomitantly retain reduction precipitate and biomass while releasing gas from the bed.

An upflow bioreactor 210 having an expanded bed 214 also provides for versatile water treatment system configurations that may utilize the benefits of the expanded bed configuration, including the ability to concurrently remove a combination of industrial effluent contaminants such as concurrent treatment of a combination of nitrate, perchlorate, selenium, or the concurrent pretreatment of nitrate, perchlorate, selenium, arsenic, or mercury.

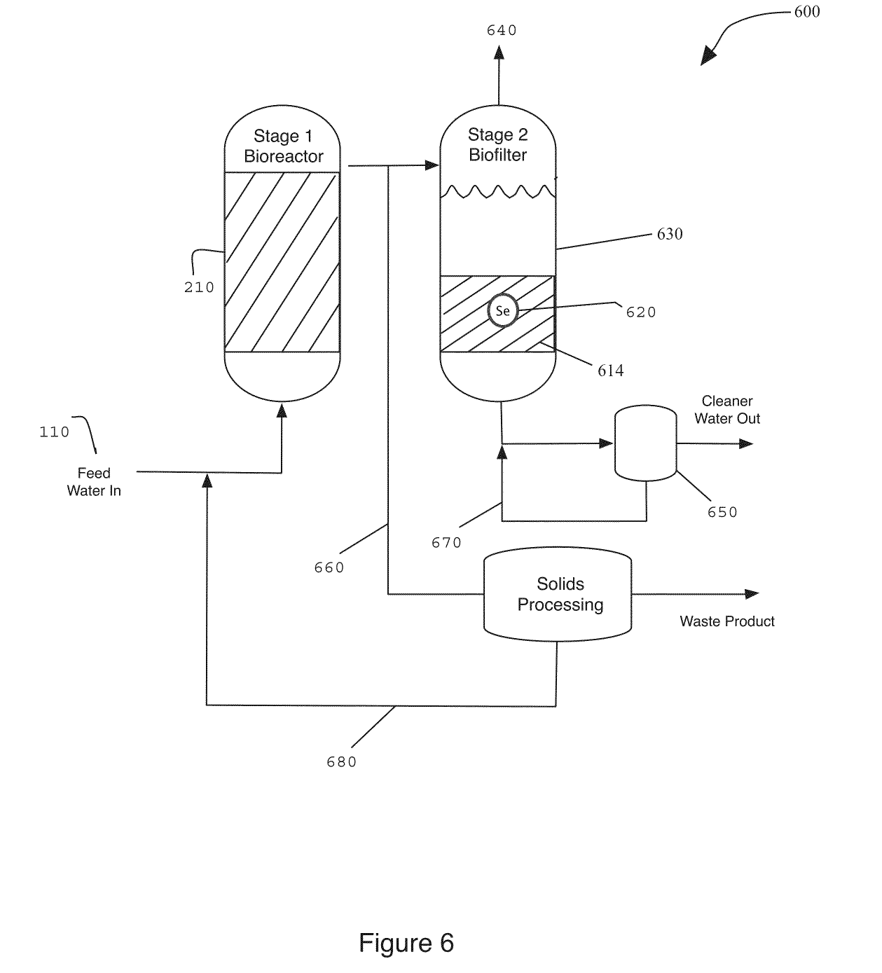

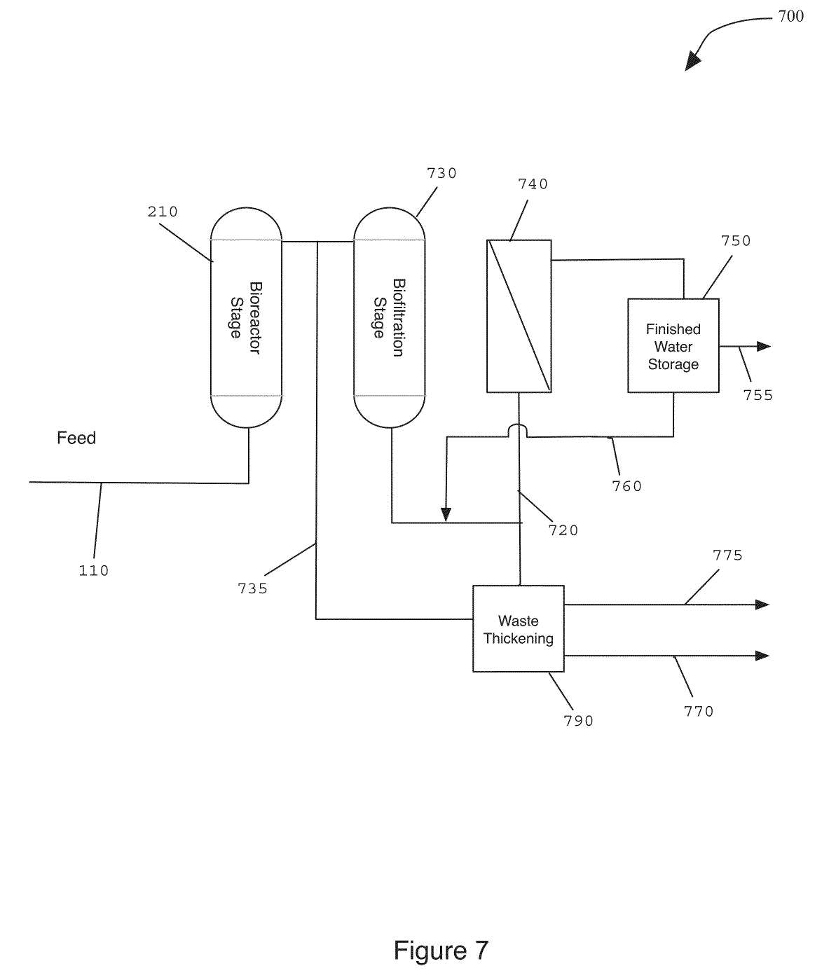

Examples of other water treatment systems using an expanded bed upflow bioreactor 210 in accordance with one or more aspects of the present invention are shown in FIGS. 6 and 7.

FIG. 6 shows an example of a multi-stage water treatment system 600 in accordance with one or more aspects of the present invention, wherein a secondary biological filter 630 may be coupled to a primary upflow bioreactor 210 for further removal of residual dissolved selenium, and or nitrate, and or perchlorate, and for further reduction of dissolved selenium in residual dissolved effluent organics, measured as COD/BOD. In this embodiment, a separate biogrowth support medium 614, which may be comprised of GAC, may be used to capture residual biological material and excess selenium nanoparticles 620 discharged from the upflow bioreactor 210.

The water level 610 in the second stage biofilter 630 may be maintained at a fixed level by drawing effluent out of the biofilter 630 with a effluent pump, or may be allowed to vary with the static pressure necessary to drive the water through an insoluble growth medium 614, such as GAC. The EBCT of the second stage biofilter 630 may be maintained in the range of 10 to 40 minutes wherein the second stage biofilter may receive effluent from the expanded bed bioreactor 210 without the addition of carbon nutrient to the water channeled to the second stage biofilter 630. Channeling effluent to the second stage biofilter 630 without adding additional carbon nutrient may culture a ‘stressed’ biofilm suitable for capturing and adsorbing any residual carbon material released from the primary bioreactor 210.

Gas produced by biological activity in the second stage biofilter 630 may remain trapped within the insoluble growth media 614 and biofilm matrix structure and may require periodic release. Degasing may be accomplished through a combination of hydraulic and or mechanical means. In one or more aspects of the present invention, gas may be released from the second stage biofilter 630 by feeding a burst of clean water 670 into the bottom of the bioreactor 630 from stored treated effluent 650.

Also, biofilm growth and bed permeability may be measured by monitoring the driving pressure across the bed in either static head or the vacuum level of the effluent. In one or more aspects of the present invention, a pressure gauge may be used to measure the static head. Also, in one or more aspects of the present invention, a effluent pressure gauge may be used to measure the vacuum level of the effluent. The effluent pressure gauge may be a compound gauge that may measure both positive and negative pressure. When the pressure reaches a level that prohibits the biofilter 630 from operating at a desired flow rate, a backwash may be performed by feeding clean water 670 into the bottom of the bioreactor 630 from stored treated effluent 650. Solids removed from the bioreactor bed 614 during the backwash event may be collected at the top of the biofilter 630 and transferred 660 to a solids handling system 690. Solids may be dewatered by conventional means creating a solid waste product and a liquid stream that may be returned 680 to the preliminary feed of the water treatment system 600.

FIG. 7 shows an example of a multi-stage water treatment system 700 in accordance with one or more aspects of the present invention, wherein the water treatment system is suitable for the concomitant removal of nitrate, mercury, arsenic, and selenium to trace levels. In this embodiment, the primary reactor 210 and the secondary reactor 730 may be coupled to a tertiary 750 filter. The tertiary 750 filter may be comprised of a dual media filtration system, microfiltration system or an ultrafiltration system. A chemical injection point 720 for introduction of ferric chloride or organosulfides may be installed upstream of the filtration system 740 to allow for addition of ferric chloride or an organosulfide compound and optional pH adjustment to optimize filter performance and metal precipitation. The addition of ferric chloride or organosulfide may promote precipitation of arsenic and mercury compounds previously reduced in the expanded bed upflow bioreactor 210 and secondary biofilter 730. Effluent from the tertiary filtration system 740 may be stored in a finished water storage tank 750 and used for periodic backwashing and degassing of both the secondary biofilter 730 and the tertiary filtration system 750. In this embodiment, waste residuals may be thickened and dewatered in a solids handling system 790 in order to bind and collect any colloidal metal material. Solid or thickened cake 775 may be removed as a waste product and liquid waste 770 may be returned to the preliminary feed of the water treatment system 700, discharged directly into the environment, or a combination thereof.

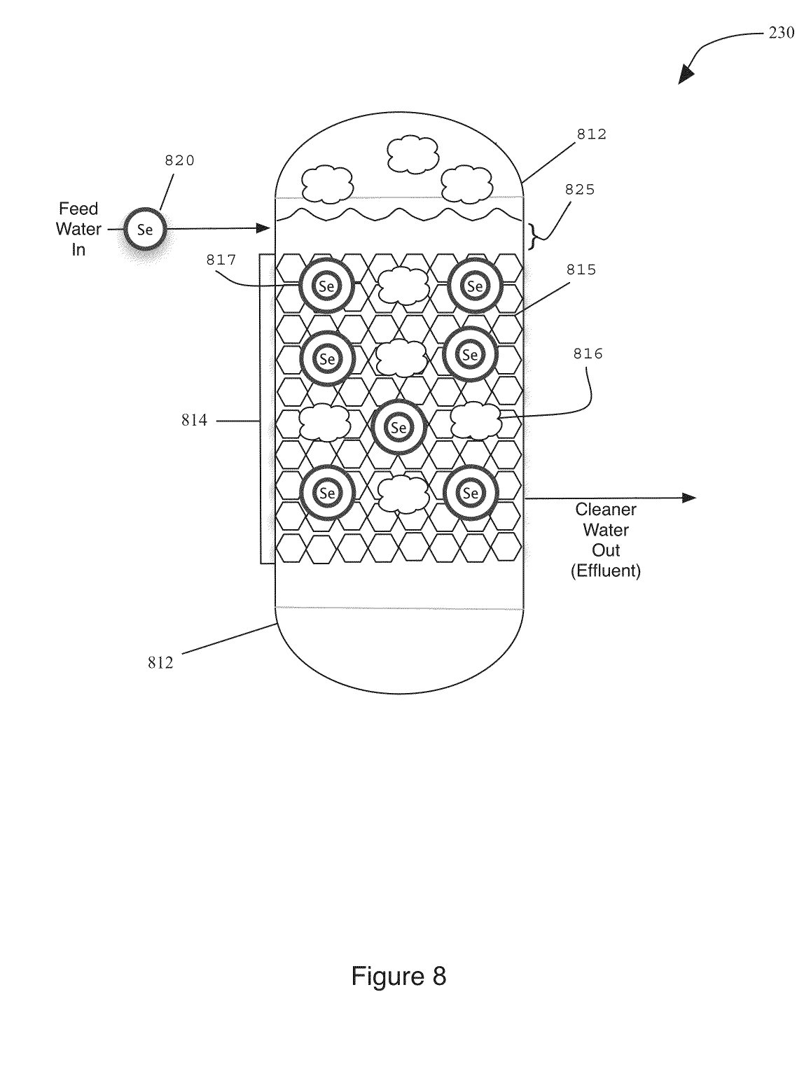

Referring again to FIG. 4A and FIG. 4B, a number of novel embodiments of the downflow bioreactor 230 and associated methods of use may be provided in accordance with one or more aspects of the present invention. As shown in FIG. 8, a downflow fixed bed reactor 230 in accordance with one or more aspects of the present invention may be comprised of a bioreactor housing 812 and a bioreactor bed 814 comprised of an insoluble growth media 815 suitable for growing a bacterial colony thereon. The bioreactor housing 812 may be comprised of carbon steel, coated carbon steel, stainless steel, fiberglass, or plastic. It should be understood that the bioreactor housings of the present invention may be comprised of any suitable material available to one skilled in the art, in addition to carbon steel, coated carbon steel, stainless steel, fiberglass, or plastic. The bioreactor housing may be made using molding, machine casting, or any other method available to one skilled in the art, which may depend on the material used to make the bioreactor housing.

The bioreactor bed 814 may be configured as a packed bed and may be between about two feet and twenty feet in depth. Bacteria may colonize on the surface of the insoluble growth media 815 to form a biofilm. The use of selected insoluble growth media 815 in the biologically active bioreactor may provide high surface area for bacterial biofilm formation. The insoluble growth media 815 may include GAC, 30-90 mesh silica, sand, green sand, or a combination thereof. In a preferred embodiment the insoluble growth media 125 may be GAC. It will be appreciated that other insoluble growth media available to one skilled in the art may also be used.

The downflow bioreactor 230 may be configured to receive feed water through an influent portal near an upper area of the bioreactor housing 812. The feed water may be pushed or pulled down through the downflow bioreactor 230 and through the packed bed 814 so that contaminants, such as selenate and selenite, and carbonaceous matter may come into contact with the biofilm in the biologically active bioreactor bed 814. Soluble contaminants may be transformed to precipitates via bacterial reduction. For example, soluble forms of selenium may be precipitated through biological reduction to a selenium precipitate. Carbon nutrient may be converted to biomass as it is consumed by the bacteria colony within the bioreactor bed 814. The bioreactor bed 814 may act as a biofilter to retain selenium precipitate or other contaminant precipitate as well as biomass. After treated feed water passes through the downflow bioreactor 230, it may be delivered out of the bioreactor 230 at an effluent port near the bottom of the bioreactor housing.

Other contaminants may also be converted by bacterial reduction in the downflow bioreactor 230 for removal, such as the reduction of nitrate and nitrite results in nitrogen (e.g., a gas) and the reduction of perchlorate results in a soluble chloride ion.

Water may be treated through the downflow bioreactor when the bioreactor bed 814 is in a production mode. In a production mode, water may be pumped or pulled through the packed bed 814 so that contaminants in the water may come into contact with the biologically active biofilm. The environment within the downflow bioreactor 230 may be maintained in anoxic (e.g., anaerobic) condition to stimulate anoxic respiration and biological reduction. The flow rate of the water may be set so feed water remains in the bioreactor 230 with sufficient reaction time, or hydraulic retention time (HRT) to reduce the contaminants to a desired level. In a preferred embodiment, the HRT may be between about 15 minutes to about 4 hours.

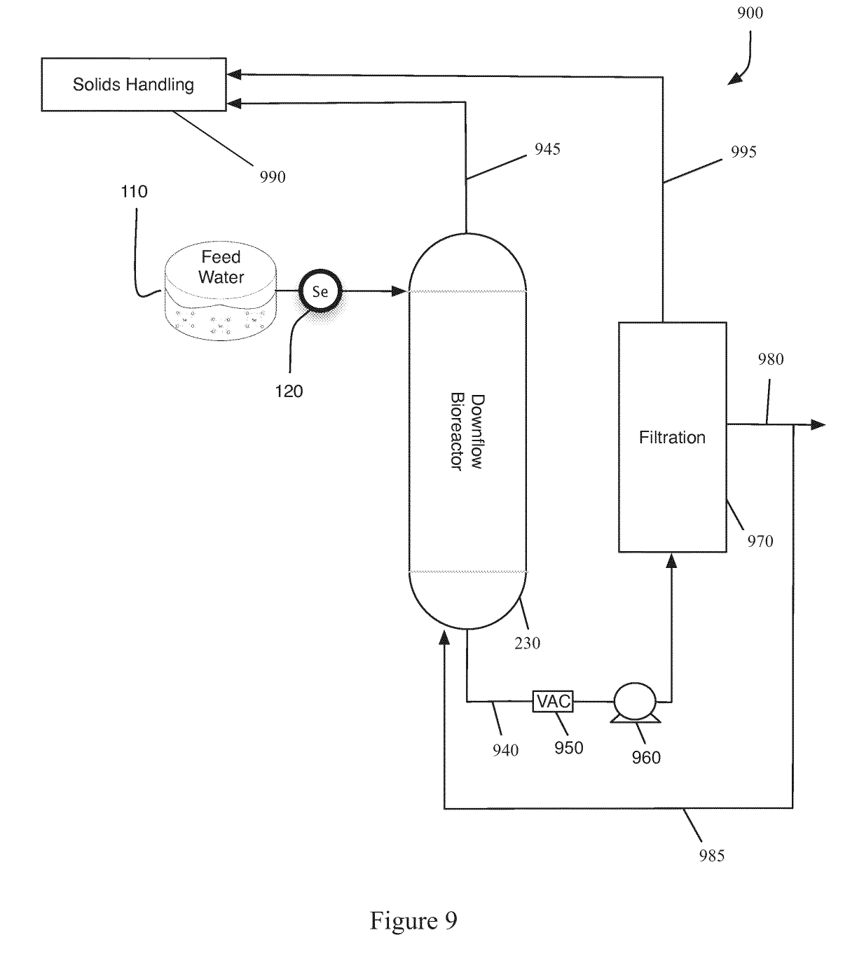

Referring now to FIG. 9, water may be pumped or pulled out of the bottom of the downflow bioreactor 230 using a effluent pump 960 downstream from the downflow bioreactor 230. Negative pressure or vacuum created by the pumping of the effluent pump 960 may provide the driving head to pull the water through the bioreactor bed 814 where dissolved contaminants may be reduced by biological activity and, in the case of precipitate end products, retained by the bed 814.

Since driving head is created below the bioreactor bed by drawing a vacuum, minimal liquid level may be needed above the bioreactor bed 814 to push the feed water through the packed bed 814. As a result, downflow bioreactor tanks in accordance with the present invention may be considerably smaller compared to conventional fixed bed bioreactor tanks, which may require a large column of water over the bioreactor bed to provide driving head. Furthermore, in conventional fixed bed bioreactors the available maximum head pressure may be limited by the height of the tank and the depth of the water column over the bioreactor bed. In one or more aspects of the present invention, maximum head pressure or head drive may not be limited by the height of the tank or the depth of the water column over the bioreactor bed 814. Thus, a downflow bioreactor in accordance with the present invention may be significantly smaller, more portable, and less expensive to construct than a conventional fixed bed bioreactor.

When the fixed bed bioreactor 230 is operating, bacterial and other biological fermentation and respiration activity within the packed bed 814 may produce gas which can become trapped in the insoluble growth media/biofilm matrix, reducing the bed permeability over time. Similarly, biomass and contaminant precipitate build up in the packed bed 814 may also reduce the bed permeability over time. Loss of bed permeability reduces bioreactor efficiency and may impede bioreactor operability.

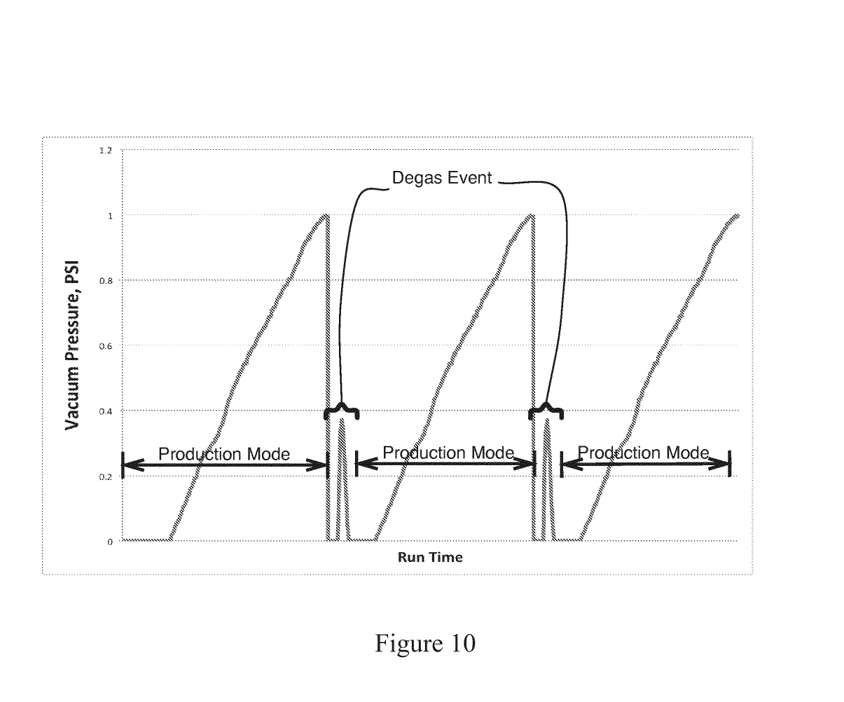

Effluent vacuum pressure may be used as an indicator of bed permeability. Thus, as shown in FIG. 10, bed permeability may be monitored using effluent pressure data which may be measured by a effluent pressure gauge 950, such as a vacuum level transmitter, associated with the downstream effluent line. Effluent pressure data may also be used to monitor head loss.

Effluent pressure data received from the effluent pressure gauge 950 may also allow monitoring of biological activity and biological reaction kinetics. Gas production is an indicator of biological activity. Thus, the rate of effluent vacuum pressure increase may indicate the biological reaction kinetics within the bioreactor bed 814. The kinetics related to gas production may be an indicator of the health of the living bacterial biofilm, which may then be optimized to further increase kinetics of the bioreactor system. Furthermore, effluent pressure data may provide the baseline effluent vacuum level that is achievable, which may be an indication of the bed porosity. Bed porosity may be used as an optimization point to control solids retention within the bed.

In accordance with one or more aspects of the present invention, an automated degassing system may be provided to release gas from the bioreactor bed 814 and restore or maintain a desired level of bed permeability. In accordance with one or more aspects of the present invention, an automated backwash system may be provided to release solids from the bioreactor bed 814 and restore or maintain a desired level of bed permeability.

The fixed bed bioreactor 230 may operate within a broad range of pressure, e.g., between about negative (−) 5 psi and about 10 psi (0-23.1 ft H2O), associated with bed permeability.

Effluent pressure data may be obtained using a compound pressure gauge connected to an effluent pathway at a position downstream from the packed bed 814. As entrained gas accumulates in the packed bed 814 and reduces bed permeability, a pressure change occurs as the effluent pump 960 attempts to suck water through the bioreactor bed 814. When effluent pressure reaches a predetermined level or falls within a predetermined range, the effluent pressure gauge may signal a backwash pump motor to turn on to initiate pumping clean water from the filtration system into a backwash water conduit. The backwash pump may include a fixed speed motor or a variable frequency drive.

In a preferred embodiment, the effluent pressure gauge may signal the backwash pump to turn on when pressure associated with suction of effluent from the downflow bioreactor is between about 2 psi and about negative (−) 2 psi. Operation of the backwash pump may be controlled by a programmable logic controller in response to data received by the programmable logic controller from the effluent pressure gauge.

Clean water from the filter system being pumped by the backwash pump may be directed by the backwash water conduit into the downflow bioreactor through a port in the bottom of the downflow bioreactor below or adjacent to a bottom portion of the packed bed 814. The upward force of the clean water being pumped into the bottom of the downflow bioreactor may help dislodge and blow out gas entrained in the packed bed. The dislodged gas may rise up through the water and be released from the downflow bioreactor through an exit port near a top area of the bioreactor. The degassing system may pump water into the bioreactor up through the packed bed for only a short duration to facilitate dislodging of gas without dislodging substantial amounts of solids or waste from the system.

During the degas event, water may flow through the bioreactor system 230 in a reverse direction at a hydraulic loading rate of about 5 to 15 gallons/minute per square foot of bioreactor surface area. The reverse flow of the water during the degas event may continue for between about 5 seconds and about 2 minutes. In a preferred embodiment, the reverse flow of the water during the degas event may continue for about 60 seconds.

After a degassing event to remove entrained gas from the packed bed 814, if effluent pressure data indicates that the packed bed has failed to recover permeability after the gas flush, then failure to recover permeability may be caused by biomass, precipitate, or other solid waste accumulating in the packed bed. When effluent pressure data received shortly after gas flush indicates continued reduced permeability, the effluent pressure control gauge may signal the backwash pump to initiate a biomass backwash event. The biomass backwash event, also known as a biomass flush, may continue until accumulated solids are transferred to a solids handling system. The biomass backwash event may continue for a substantially longer period of time than a gas backwash event. The backwash event may be manually operated or may be automated using the programmable logic controller. Parameters of the backwash pump may be set in and controlled by the programmable logic controller, wherein the programmable logic controller may operate the backwash pump in response to data received by the programmable logic controller from the effluent pressure gauge. In a preferred embodiment, the reverse flow of the water during the backwash event may continue for between about one and twenty minutes

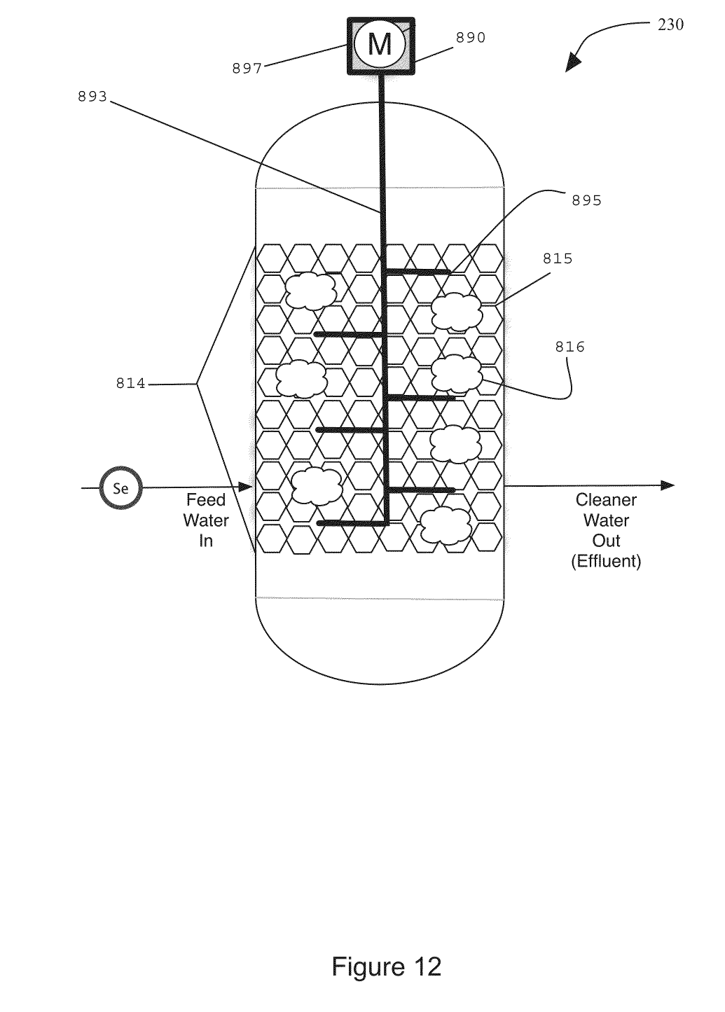

Turning now to FIG. 12, a downflow bioreactor 230 having a degassing device 890 for agitating a packed bed 814 during a degas event to assist release of gas, precipitate, and or carbonaceous matter resulting from biological activity is shown. The degassing device 890 may comprise a drive shaft 893 extending into the bioreactor bed 814, wherein the drive shaft 893 includes one or more substantially horizontal tines 895 extending laterally through the bed and may be rotated at various depths. The degassing device 890 may include a motor 897 for actuating rotation of the drive shaft 893 for agitating the bed during a degas event to assist with dislodging the entrained gas, precipitate, and or carbonaceous matter from the bioreactor bed. In a preferred embodiment, water may be pumped up through the bottom of the bioreactor bed 814 at a flow rate of between about 1 to about 15 gpm/ft2 during rotation of the degassing device 890 to further expel entrained gases from the bioreactor bed 814.

The automated degassing feature and automated backwash feature of the present invention may reduce the driving head needed to push water through the bioreactor bed by restoring and maintaining optimal bed permeability. Thus, the automated degassing feature and automated backwash feature may allow for reduced bioreactor tank height and volume. This is an important cost consideration, as the bioreactor height impacts tank volume and height, building height, shipping costs, tank wall thickness, and several other cost components.

There is thus disclosed a novel biologically active water treatment system and related methods of use. It will be appreciated that numerous changes may be made to the present invention without departing from the scope of the claims.

1. A multi-stage water treatment system comprising:
an upflow bioreactor having a bioreactor bed comprised of an insoluble growth media suitable for growing a bacteria colony thereon, wherein the upflow bioreactor is capable of receiving water from a water source and releasing water during production mode at an effluent port;
a downflow bioreactor having a bioreactor bed comprised of an insoluble growth media suitable for growing a bacteria colony thereon, wherein the downflow bioreactor is configured for receiving effluent during production mode from the upflow bioreactor and releasing water at an effluent port of the downflow bioreactor; and
wherein the effluent port of the upflow bioreactor is configured for releasing water during production mode from the upflow bioreactor at an area above the insoluble growth media of the upflow bioreactor and into the downflow bioreactor at an area above the insoluble growth media of the downflow bioreactor.

2. The water treatment system of claim 1 further comprising a contaminated water source wherein water from the contaminated water source contains soluble selenium.

3. The water treatment system of claim 1, wherein the insoluble growth media of the bioreactor bed of the upflow bioreactor comprises granular activated carbon.

4. The water treatment system of claim 1, wherein the bioreactor bed of the upflow bioreactor is configured for production mode with a substantially expanded configuration.

5. The water treatment system of claim 4, wherein the substantially expanded configuration of the bioreactor bed comprises an expansion maintained at between about 10% and about 40% of an expansion state of the insoluble growth media when in a static configuration.

6. The upflow bioreactor of claim 4, wherein the substantially expanded configuration of the bioreactor bed is not substantially fluidized during production mode.

7. The water treatment system of claim 4, wherein the substantially expanded configuration of the bioreactor bed is capable of releasing gas during production mode while substantially retaining a contaminant precipitate.

8. The water treatment system of claim 1, further comprising a filtration system configured for receiving effluent from the downflow bioreactor.

9. The water treatment system of claim 8, wherein the filtration system comprises a multi-media filtration system.

10. The water treatment system of claim 8, wherein the filtration system comprises a membrane filtration system.

11. The water treatment system of claim 10, wherein the filtration system comprises a microfiltration system.

12. The water treatment system of claim 10, wherein the filtration system comprises an ultrafiltration system.

13. The water treatment system of claim 1, further comprising a chemical injection system capable of introducing a chemical for coagulation of biomass into an effluent stream between the upflow bioreactor and the downflow bioreactor.

14. The water treatment system of claim 8, further comprising a chemical injection system capable of introducing a chemical for coagulation of biomass into an effluent stream between the downflow bioreactor and the filtration system.

15. (canceled)

16. A multi-stage water treatment system comprising:
a first bioreactor comprising a first bioreactor housing having an influent port near a bottom area of the bioreactor housing wherein the influent port is suitable for receiving contaminated water into the bioreactor housing during production mode; an effluent port near a top area of the bioreactor housing wherein the effluent port is suitable for releasing water from the bioreactor housing during production mode; a bioreactor bed comprising an insoluble growth media disposed within the bioreactor housing wherein the insoluble growth media is suitable for growing a bacteria colony thereon; wherein the bioreactor bed is disposed within the bioreactor housing so water entering the bioreactor housing through the influent port is capable of flowing upward through the bioreactor bed during production mode and exiting the bioreactor housing through the effluent port near a top area of the bioreactor housing and wherein the bioreactor bed is configured to release gas while substantially retaining a contaminant precipitate;
a second bioreactor comprising a second bioreactor housing having an influent port near a top area of the bioreactor housing wherein the influent port is suitable for receiving contaminated water into the bioreactor housing during production mode; an effluent port near a bottom area of the bioreactor housing wherein the effluent port is suitable for releasing water from the bioreactor housing; a bioreactor bed comprising an insoluble growth media disposed within the bioreactor housing wherein the insoluble growth media is suitable for growing a bacteria colony thereon; wherein the bioreactor bed is disposed within the bioreactor housing so water entering the bioreactor housing through the influent port is capable of flowing downward through the bioreactor bed and exiting the bioreactor housing through the effluent port;
wherein the first bioreactor effluent port is connected to the second bioreactor influent port by an effluent conduit for transfer of water from the first bioreactor to the second bioreactor during production mode.

17. The multi-stage water treatment system of claim 16, further comprising an effluent pump connected to a downflow bioreactor effluent conduit wherein the downflow bioreactor effluent conduit is connected to the effluent port of the second bioreactor so that the effluent pump is capable of pumping water from the second bioreactor.

18. The multi-stage water treatment system of claim 17, further comprising an effluent pressure gauge capable of measuring positive and negative pressure connected to the downflow bioreactor effluent conduit between the effluent pump and the effluent port of the second bioreactor and wherein the effluent gauge is capable of measuring pressure in an effluent stream.

19. A method of treating contaminated water using a biologically active water treatment system comprising:
providing an upflow bioreactor having a bioreactor bed comprised of an insoluble growth media suitable for growing a bacteria colony thereon, wherein the upflow bioreactor is capable of receiving water from a water source and wherein the upflow bioreactor is capable of releasing water during production mode through an upflow bioreactor effluent port at an area above the insoluble growth media of the upflow bioreactor;
providing a downflow bioreactor having a bioreactor bed comprised of an insoluble growth media suitable for growing a bacteria colony thereon, wherein the downflow bioreactor is configured to receive effluent during production mode from the upflow bioreactor at an area above the insoluble growth media of the downflow bioreactor and wherein the downflow bioreactor is capable of releasing water through a downflow bioreactor effluent port;
selecting a contaminated water containing one or more contaminants that are capable of being reduced by biological reduction comprising selenate, selenite, perchlorate, methyl mercury, arsenic, nitrate, or nitrite;
feeding the contaminated water into the upflow bioreactor so that the contaminated water travels upwards through the upflow bioreactor bed at a rate of between about two and about seven gallons per minute per foot squared; and
directing an effluent from the upflow bioreactor into the downflow bioreactor.

20. The method of claim 19, further comprising actuating an effluent pump that is connected to a downflow bioreactor effluent stream to pump water from the downflow bioreactor effluent port near a lower area of the downflow bioreactor.
